(19) United States
(12) Patent Application Publication
(10) Pub. No.: US 2008/0126179 A1
(43) Pub. Date: May 29, 2008

(54) SYSTEM AND METHOD FOR TRACKING AND PREDICTING RESPONSE TO A PRESENTATION

(75) Inventors: Aaron Norfolk, Ontario (CA); Ralph Valeriote, Ontario (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Skura Corporation, Mississauga (CA)

(21) Appl. No.: 11/849,001

(22) Filed: Aug. 31, 2007

Related U.S. Application Data
(63) Continuation of application No. 60/824,249, filed on Aug. 31, 2006.

(51) Int. Cl. G06Q 99/00

(52) U.S. Cl. 705/10

(57) ABSTRACT

There is disclosed a customer relations management (CRM) system for capturing response information to a presentation to an audience. The system includes a presentation module for presenting objects of the presentation to the audience, a tracking module for capturing the response information during presentation of the objects of the presentation to the audience, and a data storage for storing the response information. A method for capturing response information to a presentation to an audience is also disclosed.

This application claims priority from U.S. Provisional Patent Application No. 60/824,249, filed Aug. 31, 2006, and incorporated herein by reference.

### FIELD OF INVENTION

The present invention relates to a system and method for tracking and predicting response to a presentation, particularly a presentations relating to promoting a product or service.

### BACKGROUND OF THE INVENTION

Present systems and methods for tracking and predicting response to a presentation require improvement. A need therefore exists for an improved system and method for tracking and predicting response to a presentation. Accordingly, a solution that addresses, at least in part, the above and other shortcomings is desired.

### SUMMARY OF THE INVENTION

In an aspect of the present invention, there is a customer relations management (CRM) system for capturing response information to a presentation to an audience. The system comprises: a presentation module for presenting objects of the presentation to the audience; a tracking module for capturing the response information during presentation of the objects of the presentation to the audience; and a data storage for storing the response information.

The system may further comprise: a response analysis module for analyzing the response information to determine effectiveness of at least one of the objects of the presentation; and an update module for modifying the at least one of the objects on the basis of the effectiveness determined by the response analysis module.

In the system, the effectiveness determined by the response analysis module may be stored in a response report on the data storage.

The presentation module may provide a new call object in the presentation that is activatable to initiate tracking of second response information by the tracking module. The response information may be related to response of the audience during a first segment of the presentation, and the second response information may be related to response of the audience during a second segment of the presentation.

The audience may comprise at least a first and a second party. The first party may provide the response during the first segment of the presentation. The new call object may be activated as the second party joins the presentation. At least the second party may provide the response during the second segment of the presentation.

The presentation and tracking modules may be part of a client program that reside upon a mobile computing device used by a presenter to present the presentation to the audience. The response analysis and update modules may be part of a server program that resides upon a computing system remote from the mobile computing device.

The client may (i) provide the response and second response information to the server program for analysis by the response analysis module, and (ii) receive commands for modifying the at least one objects of the presentation from the update module of the server.

The client program may communicate with the server program via the Internet. The data storage may include a CRM database for storing the response information and other customer data in the CRM system.

In another aspect of the present invention, there is a method for capturing response information to a presentation to an audience. The method comprises: presenting objects of the presentation to the audience; tracking the response information during presentation of the objects of the presentation to the audience; analyzing the response information to determine effectiveness of at least one of the objects of the presentation; and modifying the at least one of the objects on the basis of the determined effectiveness.

The effectiveness determined by the response analysis module may be stored in a response report on a data storage device.

The method may further comprise initiating tracking of second response information, wherein the response information may relate to response of the audience during a first segment of the presentation, and the second response information may relate to response of the audience during a second segment of the presentation.

The audience may comprise at least a first and a second party. The first party may provide the response during the first segment of the presentation, and at least the second party may provide the response during the second segment of the presentation.

The steps of presenting objects of the presentation to the audience, and tracking the response information during presentation of the objects of the presentation to the audience, may operate on a mobile computing device.

### BRIEF DESCRIPTION OF THE DRAWINGS

The foregoing and other aspects of the invention will become more apparent from the following description of specific embodiments thereof and the accompanying drawings which illustrate, by way of ex ample only, the principles of the invention. In the drawings, where like elements feature like reference numerals (and wherein individual elements bear unique alphabetical suffixes):

FIG. 1 is a block diagram of a system for capturing response information and for providing feedback to a presentation;

FIG. 2 is a block diagram of system components at a client computing device presenting the presentation of FIG. 1;

FIG. 2a is a table of files associated with the presentation of FIG. 1;

FIG. 3 is a table of exemplary scenes associated with the presentation of FIG. 1;

FIGS. 4a to 4e are exemplary data structures associated with tracking response information to the presentation of FIG. 1;

FIG. 5a is a flow chart diagram of data flow for receiving data in the presentation of FIG. 1;

FIG. 5b is a flow chart diagram of steps for obtaining the data of FIG. 5a;

FIG. 5c is a follow chart diagram of data flow for sending data from the presentation of FIG. 1;

FIGS. 6a to 6g are flow chart diagrams of steps for sending the data of FIG. 5c;

FIG. 7 is an exemplary screen display of a presentation and navigation bar in the system of FIG. 1;

FIG. 8 is an exemplary screen display of the navigation bar of FIG. 7;

FIG. 9 is an exemplary screen display of a control screen for a presentation in the system of FIG. 1;

FIG. 10 is an exemplary screen display of an information entry screen in the system of FIG. 1;

FIG. 11 is table of exemplary scenes to an exemplary presentation in the system of FIG. 1;

FIG. 12 is a block diagram of system components at a web server of the system of FIG. 1;

FIG. 13 is a flow chart diagram of information feedback to a presentation in the system of FIG. 1.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

In an embodiment, there is a method and system for capturing response information of an audience to a presentation. The embodiment can operate with a customer relation management (CRM) system, so that response of an audience, such as of customers to a sales presentation, can be observed and captured to assist in refining or modifying the CRM, including the presentation, as deemed to be appropriate for tending to improve acceptance of messages in the presentation. The response information tracking and capture is integrated with the presentation itself in the embodiment, so that as a presenter takes an audience through the presentation, information relating to the audience's interaction with the presentation can be captured, such as the length of time that is spent on a particular information display, or if an information display is shown repeatedly as the presenter goes back to the display to address questions or issues raised from the audience.

The observing and capturing of data relating to customer response to a presentation is termed closed loop marketing (CLM), which tends to focus on integrating customer's behaviour into marketing processes.

In this description, an audience response is understood to relate to all aspects of a presentation to the audience, which may include interactive features. The response information that is observed and tracked can therefore relate to actual input the audience provides to the presentation or the presenter, the message level detail given in a presentation having hierarchical levels of detail, the time that is spent presenting a particular object of a presentation, the navigation to different aspects of a presentation, and other indicators for tracking and analyzing message acceptance by an audience.

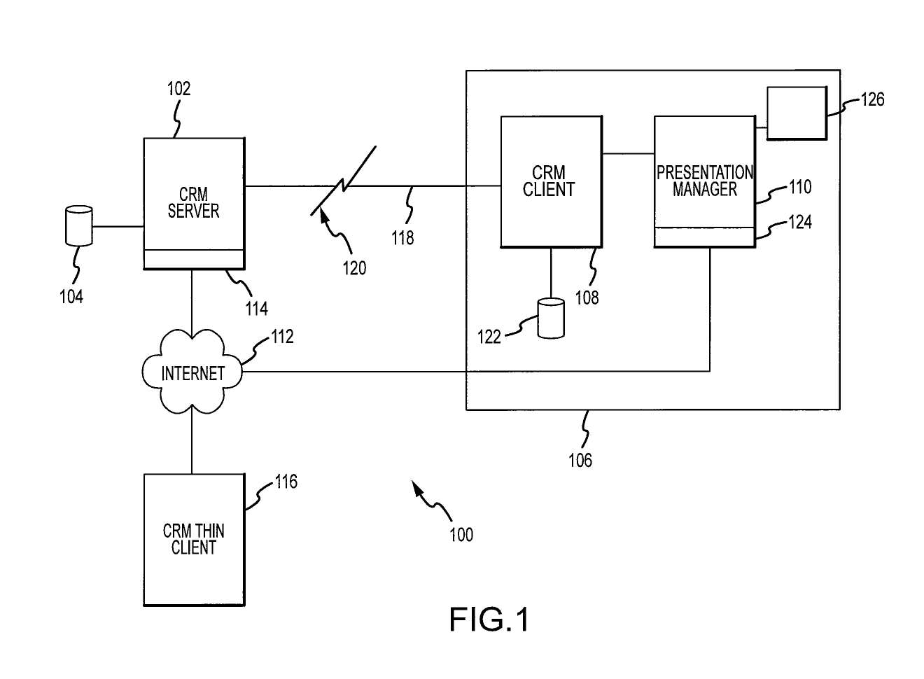

Referring to FIG. 1, there is a block diagram showing components to an exemplary system for implementing response information capture during a presentation. Therein, system 100 includes CRM server 102 operating on a computing system. System 100 includes access to local or remote CRM database 104 storing, among other things, customer relations information of the CRM system. CRM server 102 provides communications access and data management tools for organizing, maintaining, and storing CRM information.

System 100 includes a CRM client 108 that is operable, on the shown embodiment, on a mobile computing device 106 remote from the computing system of CRM server 102. Computing device 106 includes a presentation manager 110 in communication with the CRM client 108. The CRM client 108 maintains communication with CRM server 102 by way of network connection 118. Preferably, a synchronization module 120 can be provided to maintain synchronization between data held at CRM server 102 and CRM client 108. By keeping separate database storages 104 and 122 for CRM server 102 and CRM client 108, respectively, live communication over connection 118 need not always be enabled, and the CRM client 108 can function independently of CRM server 102 when connection 118 is not available, and provide synchronization updates later on by way of module 120 when communication over connection 118 is next established. It will be appreciated that other CRM information management and computer systems may be used in other embodiments.

Device 106 further provides presentation manager 110 with ability to connect to CRM server 102 directly through the Internet, without using CRM client 103 shown as network cloud 112. Presentation manager 110 may include a CRM web interface 124 that operates with web-enabled application program interfaces (API's) of CRM server 102 to communicate changes in CRM information stored at CRM database 104. In other embodiments, a web interface may be provided with CRM client 108 as well.

CRM server 102 includes a web server component 114 that includes application program interfaces (API's) for web server also by “thin” CRM client 116 over the Internet. Thin CRM client 116 in this embodiment refers to CRM access to CRM server 102 with reduced software foot print as compared to CRM client 108 with presentation manager 110 operating. It will be appreciated that in other embodiments, different connections and CRM client capabilities can be implemented, and a web server can be implemented as a separate system to CRM server 102.

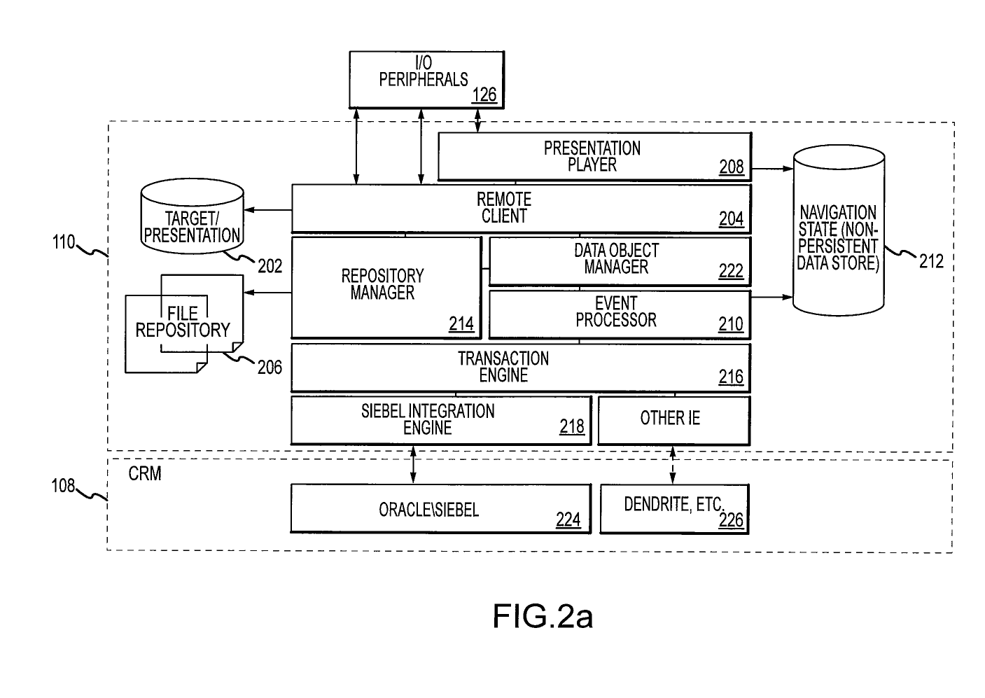

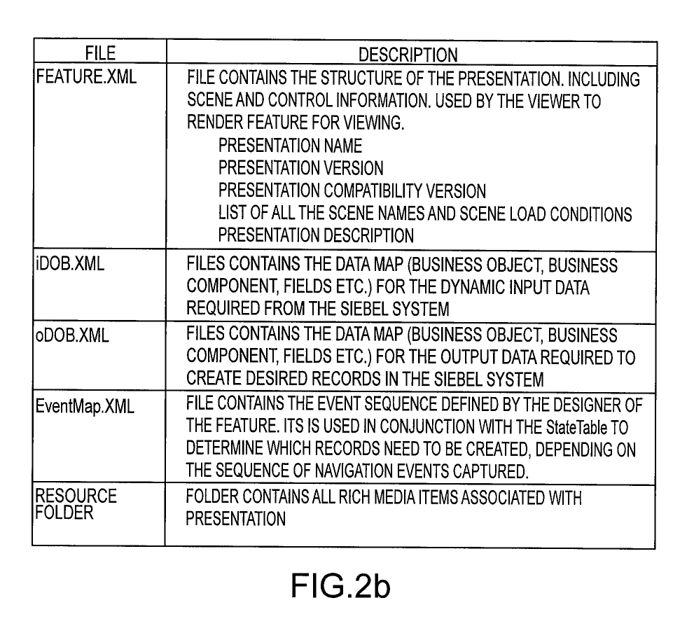

For the embodiment, presentation manager 110 provides a presentation 202 (shown in FIG. 2, thereon described below) to an audience through I/O peripherals 126, which may include a display unit and input devices such as a keyboard or mouse. Presentation manager 110 further provides tracking of response information from an audience to the presentation 202. For the embodiment, a presenter can operate device 106 to perform the presentation 202 to the audience, but it will be appreciated that in other embodiments a presenter is not required with the audience or the presentation can be launched and controlled remotely.

Referring to FIG. 2, there is a block diagram showing components of presentation manager 110. Presentation manager 110 includes a presentation 202 that can be stored at local data storage at computing device 106. For the embodiment, a presentation 202 can be also termed a “feature” having different data objects, or “scenes”, that can be read by presentation manager 110 and presented to an audience through I/O peripherals 126 by presentation player module 208. Scenes of presentation 202 can be static visual displays, interactive displays, and other audio/visual data objects such as video clips. For the embodiment, scenes can be stored and displayed in Macromedia Flash™ format, which tends to improve load times during the presentation.

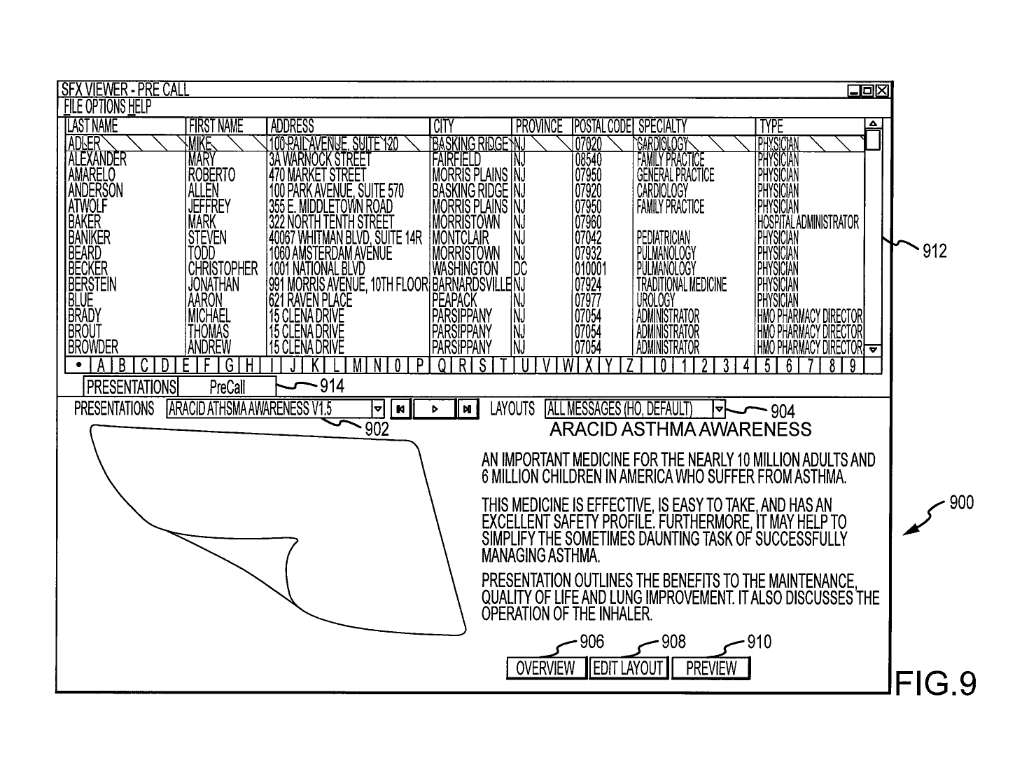

The presentation of a feature and its associated scenes is managed by a remote client, or presenter, module 204. Module 204 provides the main interface over I/O peripherals 126 to enable presentation, target an audience, to receive the presentation, layout selections, and provides refreshes thereof, as described below. Some of this functionality is enabled over a pre-call display interface, as described in FIG. 9 below. Presentation manager 110 also provides presentation player module 208 that runs presentation 202 and provides the presentation 202 to I/O peripherals 126. Along with module 204, module 208 captures response information for the presentation, including navigation information over the presentation 202.

For an embodiment, data objects such as scenes may be stored as separate data files from the presentation 202 on device 106 in a file repository 206, and the cataloguing, storage, and access of such data objects is handled by repository manager module 214. Module 214 controls and manages file repository 206 at device 106, and can extract presentation files, such as SFX, SFD and SFB files, from Siebel™ CRM systems in the embodiment.

Data object manager module 222 provides data object interaction with a CRM data management system, as described below. Module 222 manages the data definitions of data being sent and received from an underlying CRM system. The data objects handled by module 222 are in a CRM independent format in the embodiment.

Transaction engine 216 provides ability to take the CRM independent data objects managed by module 222 and convert them into CRM dependent objects, and the CRM integration engines 218 and 220 takes the CRM dependent objects and executes them against the underlying CRM system, such as a Siebel™ data system through CRM client 108.

Referring to FIG. 2a, the constituents of an exemplary presentation 202 for the embodiment is shown, for operation over a Siebel™ CRM system. Presentation 202 includes a feature.xml file that defines the structure of presentation 202. This file is defined by a designer of the feature prior to the feature presentation being rendered to presentation to an audience.

An iDOB.xml file is also provided, which includes a data map for dynamic data required from the underlying CRM system to be inserted into presentation 202. An oDOB.xml is provided to include a data map for output data relating to the captured response information to be stored into records of the underlying CRM system.

An eventmap.xml file is also associated with presentation 202. This file includes event sequences defined by the designer of presentation 202 that maps response information captured during a presentation, as described below, to records to be created in fields of the CRM system.

Finally, presentation 202 is also associated with a resource folder that contains the rich media and other items defined by the designer to be accessed as presentation 202 is played.

In the embodiment, different media objects presented to an audience are referred to as scenes. As scenes of a feature presentation 202 is presented to an audience through I/O peripherals 126, data relating to the presenting and interaction by the presenter or the audience with the scenes is tracked by client manager module 204 and presentation player module 208.

For example, passive presentation response information, such as the scene being presented, the time when a scene is loaded and the length of time spent in a scene can be observed by presentation player module 208, and such data is stored in a data store 212 in navigation state tables. Active presentation response information such as responses by an audience to a scene can be tracked as an event, which are observed by client manager module 204 and passed to event processor 210 to be captured to the navigation state tables in storage 212. For the embodiment, an event may, for example, be a response to a query such as “would you like more information (y/n)?”, in which a “y” or “n” response can be received through I/O peripherals 126 and logged as and event by event processor module 210 into state tables in storage 212. The state tables can be can be considered a response report.

In the embodiment, data storage 212 is non-persistent, and the data in the state tables are not immediately and directly written to CRM database 104 at CRM server 102 as the data is captured. Rather, the data is first written to the state tables in data storage 212, and presentation manager 110 utilizes the transaction engine module 216 to provide the data of the state tables to a CRM client 108. To provide compatibility with different CRM software systems, different integration engines may be selected for use by transaction engine module 216. In the embodiment a dedicated integration engine 218 is provided for compatibility to Siebel™ based CRM data management systems, and another general integration engine 220 is provided for other systems, such as Dendrite™ systems. This description focuses on operation with a Siebel™ system, but of course other systems can be used in other embodiments.

At the CRM client 108, compatible sister engines 224 and 226 are provided to provide communications with integration engines 218 and 220, respectively. These engines provide ability to handle CRM data requests and to provide responses back to the requesting presentation manger 110. As a CRM data request is received, the underlying CRM data management system, such as Siebel™, can handle the request as a database query, and retrieve or store data as per the CRM data request. It will be appreciated that in other embodiments, response data captured by presentation manager 110 can be written directly to a CRM system data store, or be handled in a different manner than described in FIGS. 1 and 2 for capture into a data storage system.

As described above, for the embodiment a presentation may be defined by way of a xml file that itself is stored with file repository 206, and contains metadata that defines the objects comprising a presentation. For example, the data in a feature xml file might provide as follows:

```
      <?xml version=“1.0” encoding=“utf-8” ?>
-<SFX>
-<FEATURE HEIGHT=“768” NAME=“Presentation” PREVIEW_IMAGE=“preview.jpg”
      PREVIEW_TEXT=“preview.rtf” VERSION=“1.5” WIDTH=“1024”>
  <CONDITIONS NAME=“Conditions” />
  <DATATABLES />
-<LAYOUTS DEFAULT=“1”>
-<LAYOUT TYPE=“DEFAULTLAYOUT” ID=“1” NAME=“All Scenes Enabled Layout”>
  <LAYOUTSCENE ENABLED=“True” ID=“1” NAME=“Scene 1” />
  <LAYOUTSCENE ENABLED=“True” ID=“2” NAME=“Scene 2” />
    </LAYOUT>
    </LAYOUTS>
-<NAVPANEL WIDTH=“400”>
-<SCENEPANEL ALPHA=“230.00” ALPHAC=“FFFFFF” WIDTH=“250”>
-<MENU CLOSEIMG=“” FONTBOLD=“False” FONTITALICS=“False” FONTNAME=“Verdana”
      FONTSIZE=“12’ FONTUNDERLINE=“False” ITEMSPACING=“0” OPENIMG=“” X=“10” Y=“100”>
  <NORMAL FGIN=“000000” FGOUT=“F7941D” />
  <PNORMAL FGIN=“000000” FGOUT=“F7941D” />
  <PSELECTED BK_IN_GRL=“6B9DD4” BK_IN_GRR=“6B9DD4” BK_OUT_GRL=“6B9DD4”
      BK_OUT_GRR=“6B9DD4” FGIN=“F7941D” FGOUT=“FFD13E” />
  <SELECTED_BK_IN_GRL=“6B9DD4” BK_IN_GRR=“6B9DD4” BK_OUT_GRL=“6B9DD4”
      BK_OUT_GRR=“6B9DD4” FGIN=“F7941D” FGOUT=“FFD13E” />
    </MENU>
-<TOOLBAR BACKCOLOR=“003777” BTNHEIGHT=“40” BTNWIDTH=“40” HEIGHT=“40”
      LOCATION=“BOTTOM”>
  <PIN ACTIVE=“False” HOVER=“ForwardH.png” NORMAL=“ForwardN.png”
      SELECTED=“ForwardS.png” X=“70” Y=“2” />
  <SCENELAYOUT ACTIVE=“True” BACKCOLOR=“FFFFFF” FONTBOLD=“False”
      FONTITALICS=“False” FONTNAME=“Verdana” FONTSIZE=“16” WIDTH=“250” X=“100” Y=“6”
      />
  <SELECTSCENE ACTIVE=“True” HOVER=“CheckH.png” NORMAL=“CheckN.png”
      SELECTED=“CheckS.png” X=“50” Y=“0” />
  <VIEWALL ACTIVE=“True” HOVER=“DownH.png” HOVERHIDE=“DownH.png”
      NORMAL=“DownH.png” NORMALHIDE=“DownH.png” SELECTED=“DownS.png”
      SELECTEDHIDE=“DownS.png” X=“10” Y=“0” />
    </TOOLBAR>
    </SCENEPANEL>
-<SIDEBAR BGRADIENT=“003777” BTNHEIGHT=“40” FONTBOLD=“False” FONTITALICS=“False”
      FONTNAME=“Verdana” FONTSIZE=“24” FONTUNDERLINE=“False” FORECOLOR=“000000”
      TEXTSTART=“280” TGRADIENT=“AAAAAA” WIDTH=“40”>
  <BACK DISABLED=“BackD.png” HOVER=“BackH.png” NORMAL=“BackN.png”
      SELECTED=“BackS.png” Y=“180” />
  <CANCEL HOVER=“CancelH.png” NORMAL=“CancelN.png” SELECTED=“CancelS.png” Y=“80”
      />
  <FORWARD DISABLED=“ForwardD.png” HOVER=“ForwardH.png” NORMAL=“ForwardN.png”
      SELECTED=“ForwardS.png” Y=“220” />
  <LINK ACTIVE=“False” FILE=“” HOVER=“LinkH.png” NORMAL=“LinkN.png”
      SELECTED=“LinkS.png” Y=“40” />
  <MIN HOVER=“MinH.png” NORMAL=“MinN.png” SELECTED=“MinS.png” Y=“40” />
  <NEWCALL ACTIVE=“True” HOVER=“NewCallH.png” NORMAL=“NewCallN.png”
      SELECTED=“NewCallS.png” Y=“260” />
  <PAUSE HOVER=“PauseH.png” NORMAL=“PauseN.png” SELECTED=“PauseS.png” Y=“120” />
  <SUBMIT HOVER=“SubmitH.png” NORMAL=“SubmitN.png” SELECTED=“SubmitS.png” Y=“768”
      />
    </SIDEBAR>
    </NAVPANEL>
-<POSTLAUNCH HEIGHT=“768” WIDTH=“940” X=“50” Y=“0”>
  <CALL HEIGHT=“350” WIDTH=“270” X=“5” Y=“330” />
  <SCENE TYPE=“POSTLAUNCHSCENE” HEIGHT=“650” WIDTH=“650” X=“280” Y=“30” />
  <BUTTON TYPE=“POSTLAUNCHSCENEBUTTON” HEIGHT=“25” WIDTH=“100” X=“280” Y=“5” />
  <TARGET ALTROWCOLOR=“000000” HEIGHT=“230” ROWCOLOR=“000000”
      SELCELLCOLOR=“000000” SELROWCOLOR=“000000” SORTCOLCOLOR=“000000”
      WIDTH=“270” X=“5” Y=“5” />
    </POSTLAUNCH>
-<SCENES NAME=“Scenes”>
-<SCENE BACKCOLOR=“FFFFFF” ID=“1” NAME=“Scene 1” PARENTID=“0” REQUIRED=“False”
      SCENETYPE=“NORMAL” THUMBNAIL=“safety.jpg”>
  <CONDITIONS NAME=“Conditions” />
-<CONTROLS NAME=“Controls”>
  <CONTROL TYPE=“FLASH” ALIGNMENT=“5” BACKCOLOR=“D0D0D0” BORDERACTIVE=“True”
      FILE=“03. Aracid.swf” FILLAREA=“False” HEIGHT=“768” ID=“1” NAME=“Flash 1”
      QUALITY=“1” SHOWMENU=“False” SUNKENBORDER=“False” WIDTH=“1024” X=“0” Y=“0” />
    </CONTROLS>
    </SCENE>
-<SCENE BACKCOLOR=“FFFFFF” ID=“2” NAME=“Scene 2” PARENTID=“0” REQUIRED=“False”
      SCENETYPE=“NORMAL” THUMBNAIL=“24.gif”>
  <CONDITIONS NAME=“Conditions” />
-<CONTROLS NAME=“Controls”>
  <CONTROL TYPE=“FLASH” ALIGNMENT=“5” BACKCOLOR=“D0D0D0” BORDERACTIVE=“True”
      FILE=“04. Aracid.swf” FILLAREA=“False” HEIGHT=“768” ID=“2” NAME=“Flash 2”
      QUALITY=“1” SHOWMENU=“False” SUNKENBORDER=“False” WIDTH=“1024” X=“0” Y=“0” />
    </CONTROLS>
    </SCENE>
    </SCENES>
  <VARS NAME=“Variables” />
    </FEATURE>
    </SFX>
```

As shown above, a feature xml file can define links to different data objects to be included in the presentation (such as the references to “scenes”), and properties relating to the presentation (such as the references to fonts and other properties). It will be appreciated that the xml file format is one of many ways in which a presentation may be defined and stored with presentation manager 110.

In an embodiment, an exemplary use of CRM system 100 is to provide assistance to a sales force in the pharmaceutical industry. For example, the system can be used to make a presentation relating to a new pharmaceutical to a doctor at the doctor's office. Such a promotional visit can be termed a “call” by a salesperson, who is also the presenter.

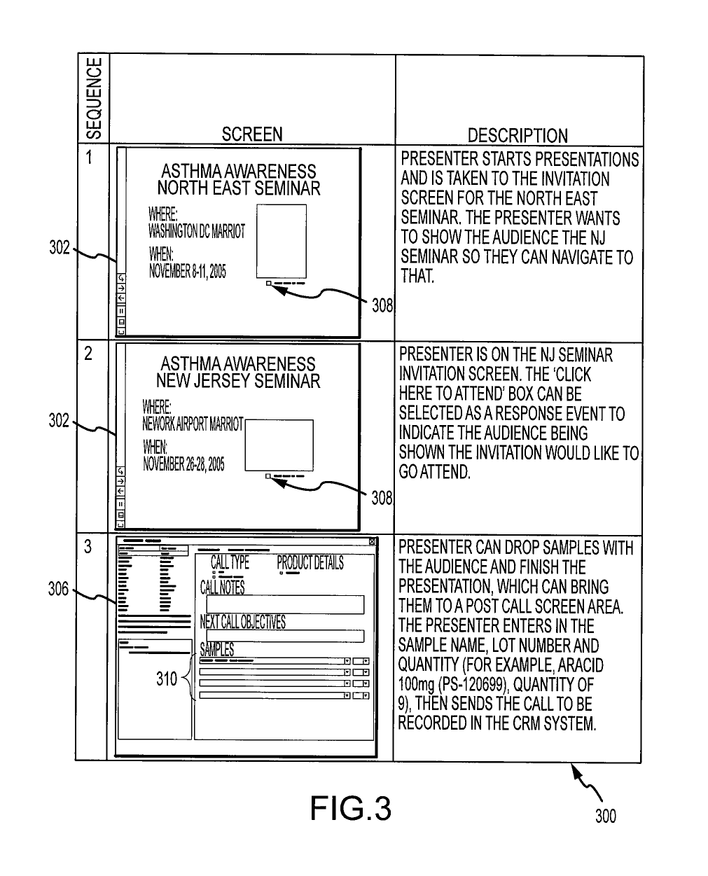

Referring to FIG. 3, there is shown a table of excerpts of an exemplary presentation 202 of a notional product “Aracid”. As shown, presentation 202 has two scenes 302 and 306 shown in a sequence (numbered 1 to 3 in table 300). For presentation 202, each scene is a screen display that can be displayed through I/O peripherals 126 at the mobile computing device 106, which the presenter can bring into a doctor's audience. Preferably, device 106 is a tablet PC with Siebel™ client software running on CRM client 108, which in turn has connections with Siebel™ software operating with CRM server 102 and synchronization module 120. In this scenario, the doctor would be the audience to presentation 202.

This example shown in FIG. 3 relates to the capture of response information from the audience. Referring to scene 302, the presenter can bring up a display relating to a seminar that the doctor can attend, as shown in the screen display of table 300 for sequence no. 1. Scene 302 include a checkbox 308 that can be selected using I/O peripherals 126, as shown in the screen display of sequence no. 2 of table 300. The selecting of checkbox 308 is a response information that is captured by presentation manager 110. Referring to another exemplary scene 306 as shown in the screen display of sequence no. 3 of table 300. The scene 306 can be presented to an audience, for example, when the presenter would like to drop of samples with the audience as presentation 202 is completed. To assist with tracking of the samples that are left with the audience, scene 306 has an area 310 that permits information regarding samples to be entered. The sample of the product that is left and the quantity that is left can be entered into area 310, which entered data can also be captured as response information for storage into the CRM system.

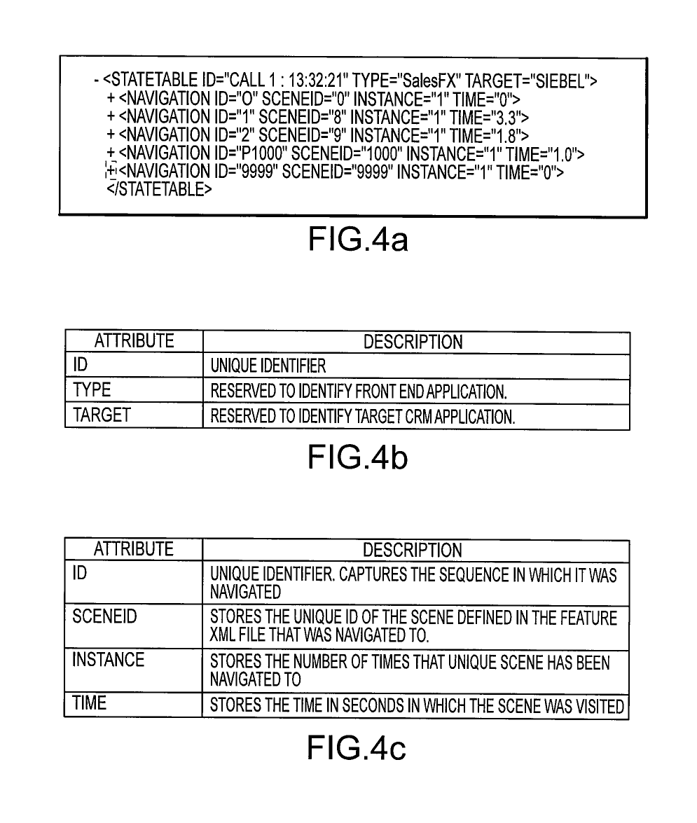

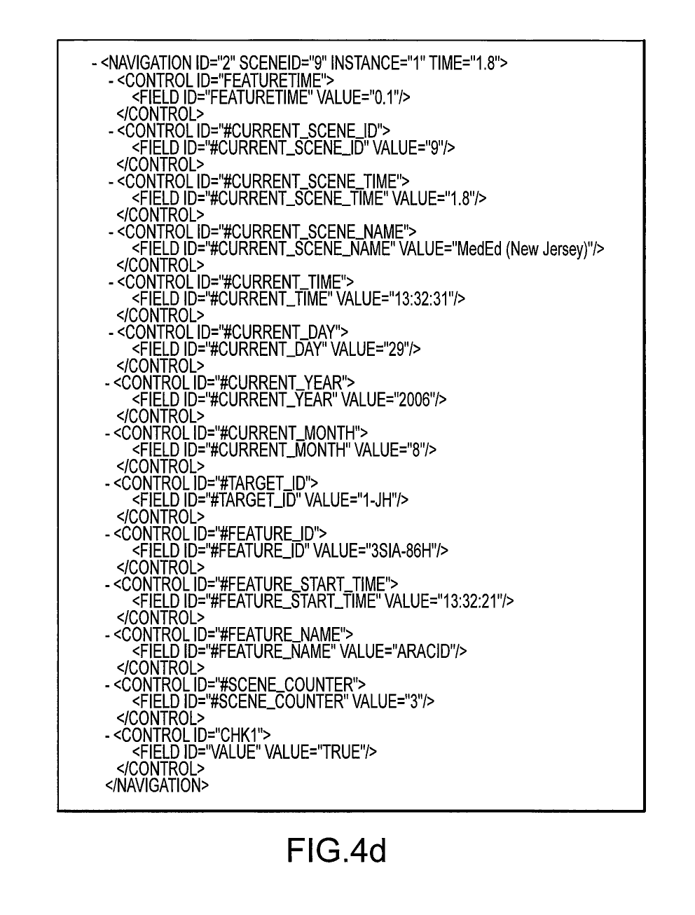

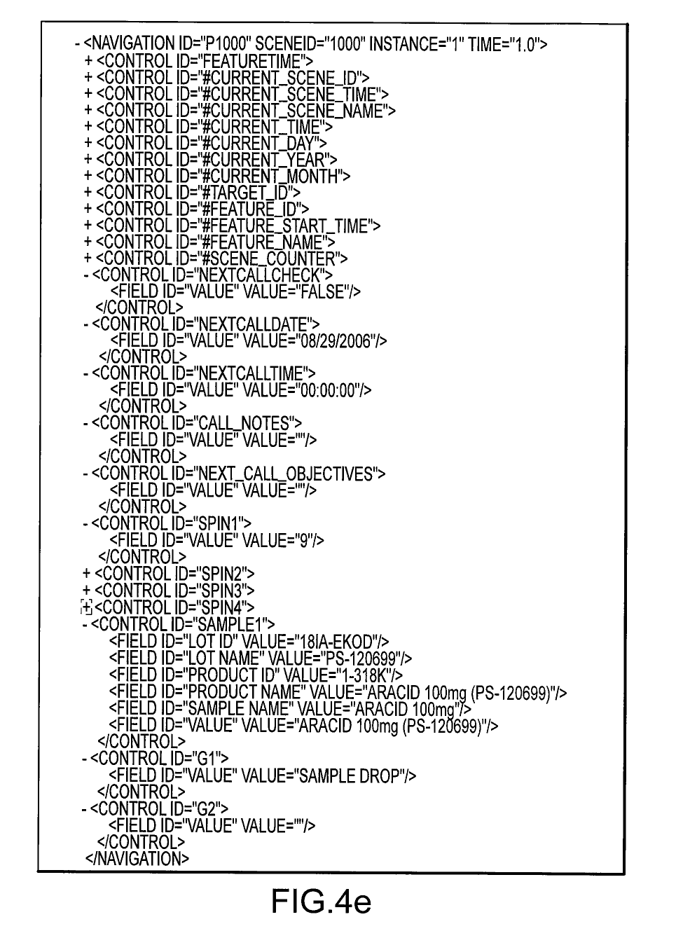

Referring now to FIGS. 4a-4g, a description of the capturing of information from scenes 302 and 306 shown in FIG. 3 as presentation 202 is played for an audience is provided. As described above, as an audience views presentation 202, data regarding responses is logged by presentation manager 110 into data store 212 as navigation state tables. In FIG. 4a, an exemplary navigation state table of data for the presentation of scenes 302 and 306 is shown. FIGS. 4b and 4c provides descriptions of state table attributes and navigation point attributes, respectively for state table. In FIG. 4a, five navigation points, or events, are shown to be logged with a navigation ID for each navigation point. In this example, Navigation ID=“0” refers to the start of presentation 202 at time 0, and Navigation ID=“9999” refers to the end of presentation. The other navigation points in-between logs response information regarding other aspects of the presentation to the audience. For example, for the event with Navigation ID=“2”, it is logged that the data object identified as SceneID=“9” as shown, which scene has been navigated to once during the presentation, and that the scene was visited for 1.8 time units (or seconds in this embodiment). In this example, SceneID=“9” refers to scene 302 of presentation 202, and SceneID=“P1000” refers to scene 306 of presentation 202.

Additional data is captured for each navigation point and tracked by the state table. Referring to FIG. 4d, the data structure for the exemplary navigation point identified Navigation ID=“9” is shown, as the information for that navigation point is expanded from the navigation state table view of FIG. 4a. An exemplary set of different variables of the data structure that can be captured by the state table at the navigation point level is shown below:

| System Variable | Description |
|---|---|
| #SCENE_COUNTER | Contains the number of Scene transitions have occurred |
| | during the Active Presentation |
| #FEATURE_NAME | Contains the name of the currently loaded Presentation |
| #FEATURE_START_TIME | Contains the start time of the Presentation |
| #FEATURE_ID | Contains the Unique ID of the Presentation |
| #TARGET_ID | Contains the Unique ID of the target audience (such as a |
| | Contact, Account, etc.) that can be selected by the |
| | presenter before starting the presentation |
| #CURRENT_YEAR | Contains the Current Year of the current system time |
| #CURRENT_MONTH | Contains the Current Month of the current system time |
| #CURRENT_DAY | Contains the Current Day of the current system time |
| #CURRENT_TIME | Contains the Current Time of the current system time |
| #CURRENT_SCENE_NAME | Contains the name of the Currently active Scene in the |
| | active Presentation |
| #CURRENT_SCENE_ID | Contains the Unique ID of the current Scene in the active |
| | Presentation |
| #CURRENT_SCENE_TIME | Contains the amount of time spent on the Current Scene in |
| | the active Presentation |

Referring to FIG. 4f, another exemplary set of information for the state table at the navigation level for the navigation point identified as Navigation ID=“P1000” is shown. This set of data relates to the capture of information relating to samples left behind with an audience, as per scene 306 shown in presentation 202 described above. As seen in FIG. 4f, data additional to that shown in FIG. 4e is provided, which include tracking information for identifying the sample product that was left behind, and the quantity that is left behind with the audience, as shown in area 402. This and other response information can tend to be also useful in meeting regulatory requirements relating to the provision of pharmaceutical product samples and the collection of data in promotional activities.

For the embodiment, navigation state tables are stored as .xml files and managed by data object manager 222. As data is being tracked for presentation 202, an output .xml file (eg., odob.xml) is created in data store 212 on computing device 106, to store the state table(s) relating to the presentation and response information thereto. The information in the output data objects collection can then be passed through transaction engine 216 to a CRM integration engine 218 for passage to CRM client 108, which as described above for this embodiment updates CRM information on CRM server 102. As described above and below, the mapping of data from the object(s) to CRM data fields is provided in an adob.xml file. It will be appreciated that in other embodiments, other file formats, including non-text or encrypted file or memory storage formats, can be used to track response information.

The interaction between presentation manager 110 and the customer data of CRM server 102 within CRM system 100 is now described. As briefly described above, for the embodiment non-CRM specific data is managed in .xml format by data object manager 222, and such data is integratable with an underlying CRM system by way of CRM transaction engine 216 and its underlying integration engine. In the embodiment, for data requests of presentation manager 110, an input idob.xml file can be used by transaction engine 216 to map the non-specific CRM data fields to a CRM specific format (such as in Siebel™ format). For data storage requests, an output odob.xml file can be used to provide similar data mappings.

Examining first the input side, in generating presentation 202 for display by player module 208, there may be data fields in presentation 202 for which input data objects from different sources are required, such as flash video from file repository 206 and target customer data for the customer the presenter is about to visit from the underlying CRM system. As described above, for the embodiment the CRM data set is generally managed by CRM server 102 in CRM data store 104, but a synchronizable copy is also stored at data store 122 for CRM client 108 to utilize when a connection from mobile device 106 to CRM server 102 is not available or not desirable. As such, the underlying CRM data set, whether from CRM client 108 or server 102, is transparent to presentation manager 110.

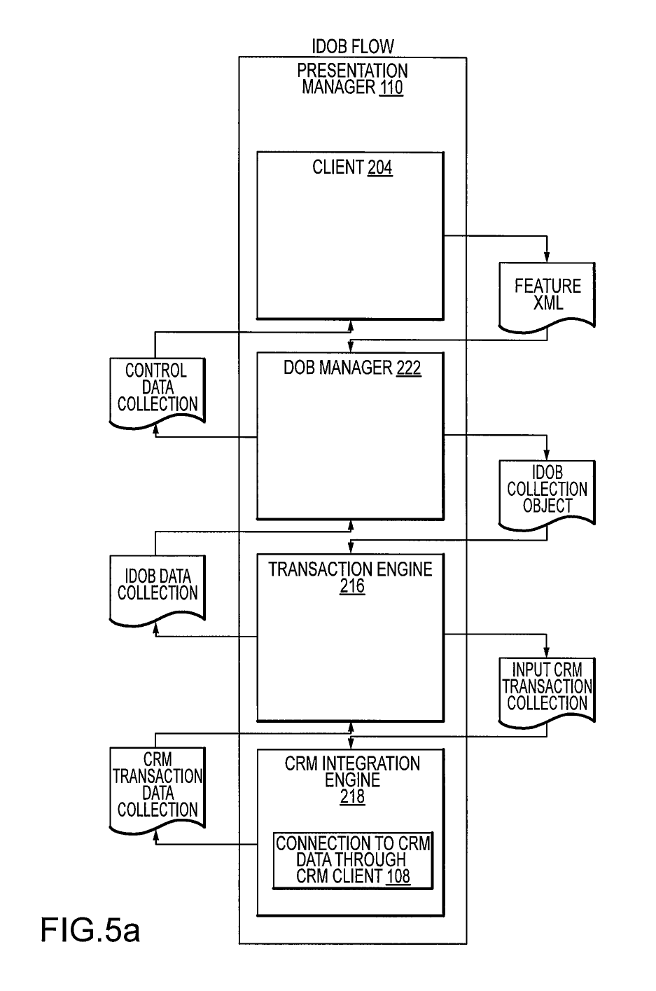

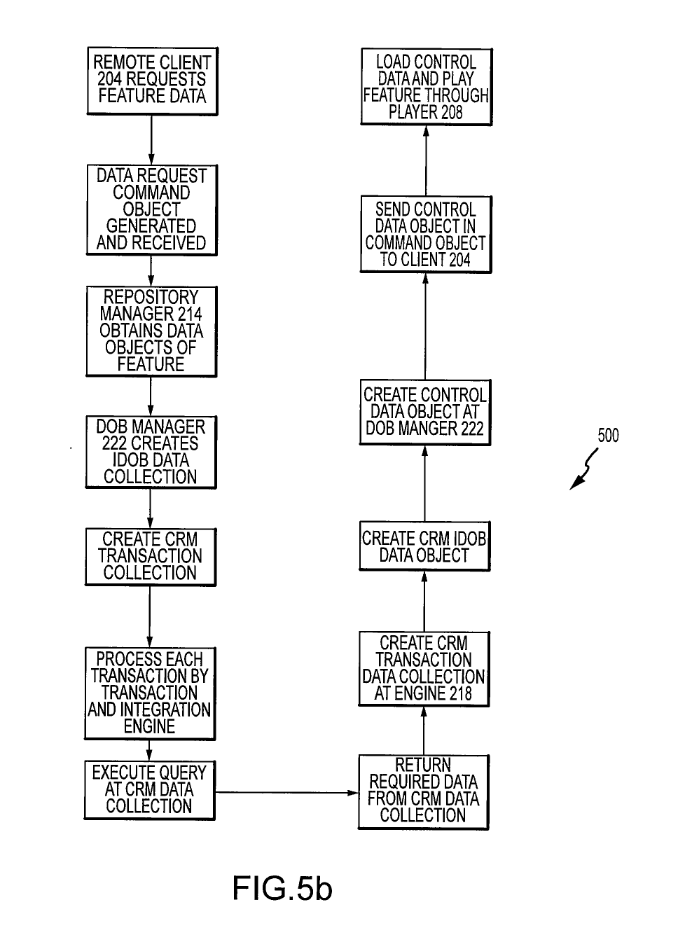

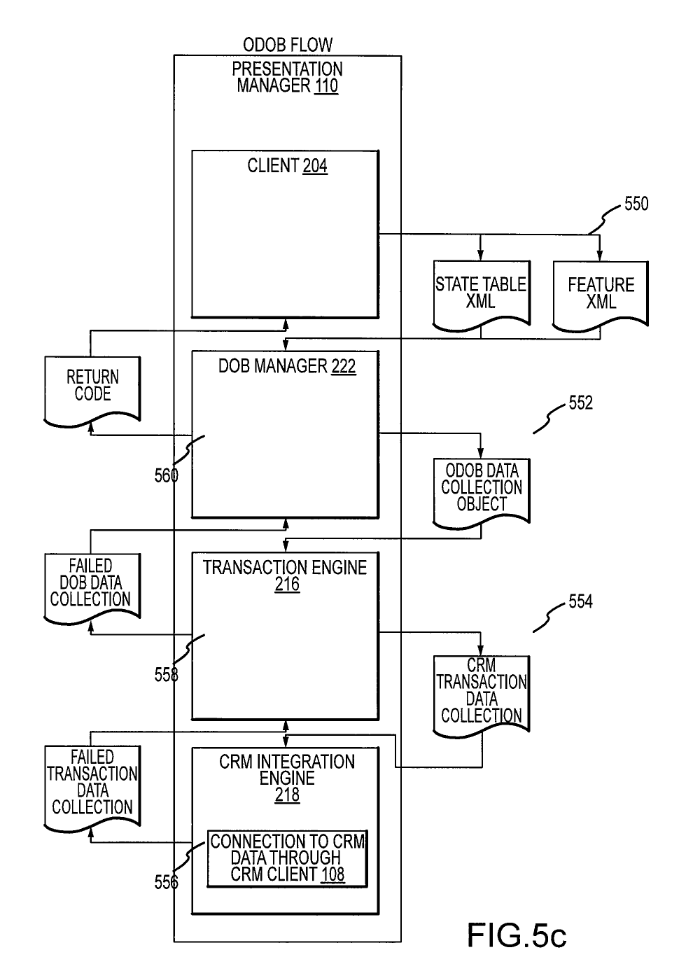

Referring to FIG. 5a, there is a block flow chart showing data flow of a request for input data requested by presentation manager 110 from a CRM data set, to be incorporated into a presentation to be presented to an audience. In FIG. 5a, remote client module 204 sends a request for CRM data to form part of a feature presentation, which data is set out in a feature xml file that is read by data object manager 222. The feature xml file sets out the dynamic data that a particular presentation would like to receive. Data object manager 222 generates data structure for the requested data in CRM independent format an input data object (IDOB) collection object, which along with CRM mapping information specified in iDOB.xml, are passed to transaction engine 216 for generating an input CRM transaction collection in a CRM dependent format. The transaction engine 216 which parses the IDOB collection object into one or more transactions, or access requests, to the CRM data set. This CRM transaction collection is then passed to CRM integration engine 218 for accessing the CRM data set, such as for example, through communicating with CRM client 108. Contents of an exemplary iDOB.xml file are provided below:

```
  <?xml version=“1.0” encoding=“UTF-8” ?>
-<DOBS>
-<DOB ID=“iDOB1” NAME=“Sample Products” PARENTID=“” TYPE=“Input”
    DATASOURCE=“Siebel”>
-<DATASOURCE BO=“Pharma Personal Products & Samples” BC=“Pharma
    Personal Samples List” VIEWMODE=“AllView” SEARCHSPEC=“”
    SORTSPEC=“Sample (ASC)” ACTION=“Return”>
-<FIELDS>
  <FIELD ID=“Product Id” VALUE=“” DATAMASK=“” />
  <FIELD ID=“Product Description” VALUE=“” DATAMASK=“” />
  <FIELD ID=“Sample” VALUE=“” SEARCHSPEC=“” DATAMASK=“” />
  <FIELD ID=“Product Type” VALUE=“” SEARCHSPEC=“‘Sample’” DATAMASK=“” />
    </FIELDS>
    </DATASOURCE>
    </DOB>
-<DOB ID=“iDOB2” NAME=“JOI Sample Lots” PARENTID=“” TYPE=“Input”
    DATASOURCE=“Siebel”>
-<DATASOURCE BO=“Pharma Samples - CE” BC=“Pharma Sample Stocked Lots”
    VIEWMODE=“” SORTSPEC=“Parent Product (ASC)” ACTION=“Return”>
-<FIELDS>
  <FIELD ID=“Id” VALUE=“” DATAMASK=“” />
  <FIELD ID=“Type” VALUE=“” SEARCHSPEC=“Lot” DATAMASK=“” />
  <FIELD ID=“Parent Product Id” VALUE=“” DATAMASK=“” />
  <FIELD ID=“Parent Product” VALUE=“” DATAMASK=“” />
  <FIELD ID=“Lot Name” VALUE=“” DATAMASK=“” />
  <FIELD ID=“Inventory Flag” VALUE=“” DATAMASK=“” />
  <FIELD ID=“Description” VALUE=“” DATAMASK=“” />
    </FIELDS>
    </DATASOURCE>
-<DATAMAP ID=“SAMPLE”>
-<FIELDS>
  <FIELD ID=“Lot Id” VALUE=“” DATAMASK=“[iDOB2.Id]” />
  <FIELD ID=“Lot Name” VALUE=“” DATAMASK=“[iDOB2.Lot Name]” />
  <FIELD ID=“Product Id” VALUE=“” DATAMASK=“[iDOB2.Parent Product Id]” />
  <FIELD ID=“Product Name” VALUE=“” DATAMASK=“[iDOB1.Sample]@Parent
    Product Id=Product Id= + ‘ (’ + [iDOB2.Lot Name] + ‘)’” />
  <FIELD ID=“Sample Name” VALUE=“” DATAMASK=“[iDOB1.Sample]@Parent
    Product Id=Product Id=” />
    </FIELDS>
    </DATAMAP>
    </DOB>
-<DOB ID=“iDOB3” NAME=“Contacts” PARENTID=“” TYPE=“Input”
    DATASOURCE=“Siebel”>
-<DATASOURCE BO=“Contact” BC=“Contact” VIEWMODE=“” SORTSPEC=“”
    ACTION=“Return”>
-<FIELDS>
  <FIELD ID=“Id” VALUE=“[TARGETID]” DATAMASK=“” />
  <FIELD ID=“My Position Id” VALUE=“” SEARCHSPEC=“@PositionId@”
    DATAMASK=“” />
  <FIELD ID=“Type” VALUE=“” DATAMASK=“” />
  <FIELD ID=“Primary Specialty” VALUE=“” DATAMASK=“” />
  <FIELD ID=“State” VALUE=“” DATAMASK=“” />
    </FIELDS>
    </DATASOURCE>
-<DATAMAP ID=“CONTACT”>
-<FIELDS>
  <FIELD ID=“Id” VALUE=“” DATAMASK=“[iDOB3.Id]” />
  <FIELD ID=“Type” VALUE=“” DATAMASK=“[iDOB3.Type]” />
  <FIELD ID=“Specialty” VALUE=“” DATAMASK=“[IDOB3.Primary Specialty]” />
  <FIELD ID=“State” VALUE=“” DATAMASK=“[iDOB3.State]” />
    </FIELDS>
    </DATAMAP>
    </DOB>
-<DOB ID=“iDOB4” NAME=“ResponseType” PARENTID=“” TYPE=“Input”
    DATASOURCE=“Siebel”>
-<DATASOURCE BO=“PickList Generic” BC=“PickList Generic” VIEWMODE=“”
    SORTSPEC=“Order By” ACTION=“Return”>
-<FIELDS>
  <FIELD ID=“Id” VALUE=“” DATAMASK=“” />
  <FIELD ID=“Type” VALUE=“” SEARCHSPEC=“COMM_RESPONSE_TYPE”
    DATAMASK=“” />
  <FIELD ID=“Value” VALUE=“” DATAMASK=“” />
  <FIELD ID=“Name” VALUE=“” DATAMASK=“” />
    </FIELDS>
    </DATASOURCE>
-<DATAMAP ID=“RESPONSETYPE”>
-<FIELDS>
  <FIELD ID=“Id” VALUE=“” DATAMASK=“[iDOB4.Id]” />
  <FIELD ID=“Type” VALUE=“” DATAMASK=“[iDOB4.Type]” />
  <FIELD ID=“Value” VALUE=“” DATAMASK=“[iDOB4.Value]” />
  <FIELD ID=“Name” VALUE=“” DATAMASK=“[iDOB4.Name]” />
    </FIELDS>
    </DATAMAP>
    </DOB>
    </DOBS>
```

The CRM data request is then processed as described above by the underlying CRM data management system, which then locates and returns the requested data in the underlying CRM system to CRM integration engine 218. This returned data is placed onto a CRM transaction data collection as responses to the one or more separate transaction requests set out iii the input CRM transaction collection, and is passed back to transaction engine 216. Transaction engine 216 then translates the transaction responses back to non-CRM dependant format using the iDOB map into an IDOB data collection for data object manager 222. This output is a data collection that is then mapped to the controls of the requested data set out in the feature.xml file as the control data collection, which is passed back to remote client 204 for integration with a presentation to be presented through presentation player module 208 to an audience.

Referring to FIG. 5b, there is a flow chart 500 showing the different steps of operation of CRM data retrieval, as described above, along with retrieval of other data for an exemplary presentation, such as presentation 202. In chart 500, the process starts with input from the presenter through I/O peripherals 126 to presentation manager 110 that a particular feature presentation, for example, presentation 202 is desired to be loaded. Data relating to the particular target audience can also be entered through I/O peripherals 126. Such information is passed to remote client module 204 for processing, which generates a request command object, which is passed to repository manager module 214 and data object manager module 222. Repository manager module 214 retrieves the feature data and feature.xml file stored at mobile device 106 relating to presentation 202 from file repository 206. For the CRM data, data object manager 222 creates an input (or, idob) data collection, which is already described is converted into a CRM transaction collection request for CRM data that is passed through transaction engine module 216. Thereat, a CRM transaction is passed through to CRM integration engine 218, which translates the request into an appropriate database query for the CRM data collection for execution upon the data collection. Once the requested CRM data is returned from the query, that data is passed back through integration engine 218 and transaction engine 216 to create CRM transaction data collection as the results of the requested data. That data collection is then passed to data object manager 222 to create an idob data object based on the data collection received. The data collection is then passed onto client module 204 to integrate the CRM data, with other feature data into presentation 202 which can then be provided to presentation player module 208 for displaying to an audience through I/O peripherals 126.

Turning now to a discussion of output data from presentation manager 110, reference is made to FIG. 5c. Before starting the data flow shown in the block diagram of FIG. 5c, presumably response information to a presentation has already been captured in state tables and presentation manager 110 is now wishing to write that data to the underlying CRM data system. The odob.xml and eventmap.xml files provides a mapping of the data in the navigation state table(s) in the output data objects for response information as described above, and the feature xml file with any data updates to CRM data not relating to response information, are both passed by client module 204 to data object manager 222 by client module 204 (step 550). Data object manager 222 provides, through the map files, a mapping of the data held in the output data objects to appropriate fields and records to be generated or updated in the CRM data set. This information along with the ODOB data collection object (step 552) are passed to transaction engine 216. Odob.xml and eventmap.xml files are similar to an idob.xml file, and the example above of an idob.xml file is sufficient for a person of skill in the art to implement the other xml mapping files. The ODOB data collection is parsed by transaction engine 216 using odob.xml into one or more CRM dependent transactions, or actions, to be taken with the CRM data set to update it with information. These transactions are placed into a CRM transaction data collection (step 554) to be passed to CRM integration engine 216. Through its connection to the CRM data set, CRM integration engine 216, the one or more CRM transactions are processed to update the CRM data set by way of query commands available to the underlying CRM data management system.

After processing is complete by the CRM data management system, CRM integration engine 216 generates a failed transaction data collection (step 556), noting any CRM transaction that was not properly processed. For the embodiment, the failed transaction data collection can be a null-set, which indicates that all transactions were processed without error. The failed transaction data collection is passed to transaction engine 216 to be mapped into a failed DOB data collection (step 558) having the data that was not properly stored to the CRM data set. Like the failed transaction data collect, the DOB data collection can be null in the embodiment to indicate a completely successful CRM data update. The data object manager 222 receives the DOB data collection, and provides a return code to client module 204 (step 560) indicating success or failure of the update, and client module 204 can in turn notify a use of system 100 through I/O peripheral 126 the success or failure of the CRM data update. For the embodiment, a failed DOB data collection can be maintained at device 106 to be sent through transaction engine 216 again for processing to complete an update of the CRM data.

For the embodiment, as described above the mapping of xml data to data fields in the CRM data set is by way of a event map file and appropriate dob.xml files. It will be appreciated that other mapping and data transfer techniques can be used in other embodiments.

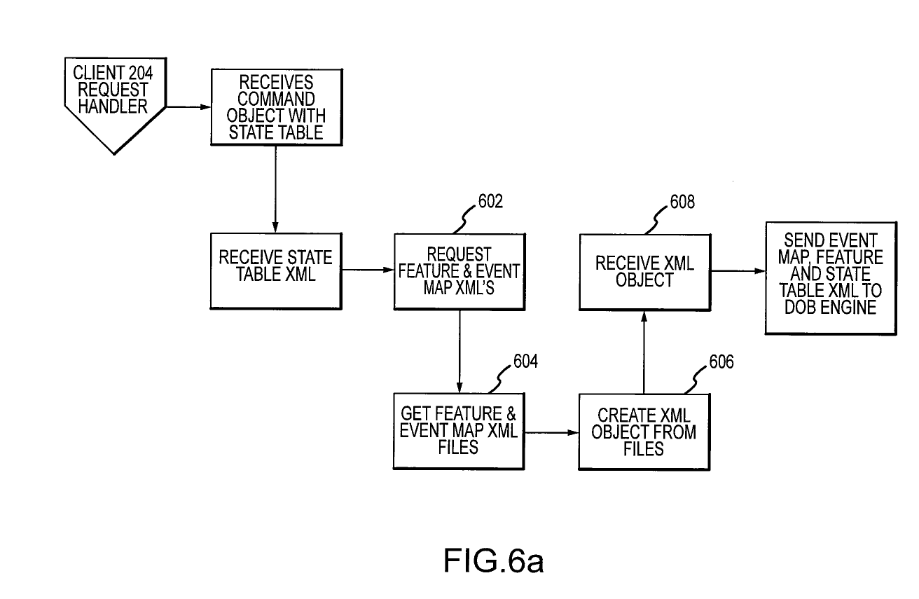

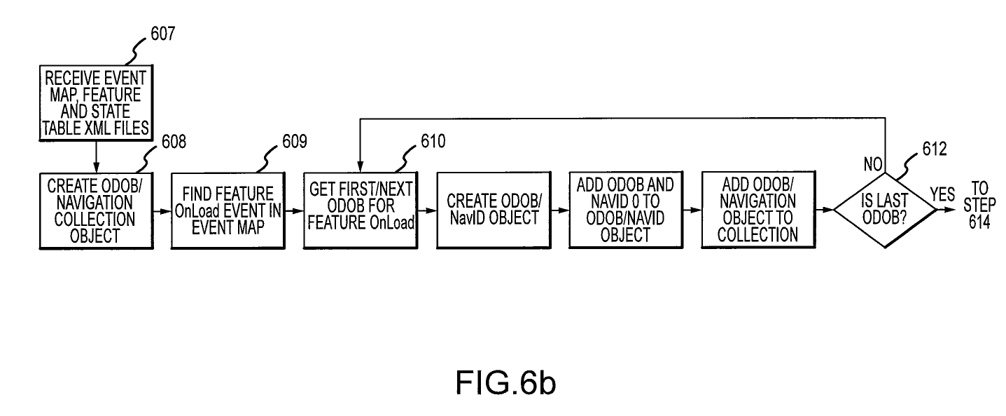

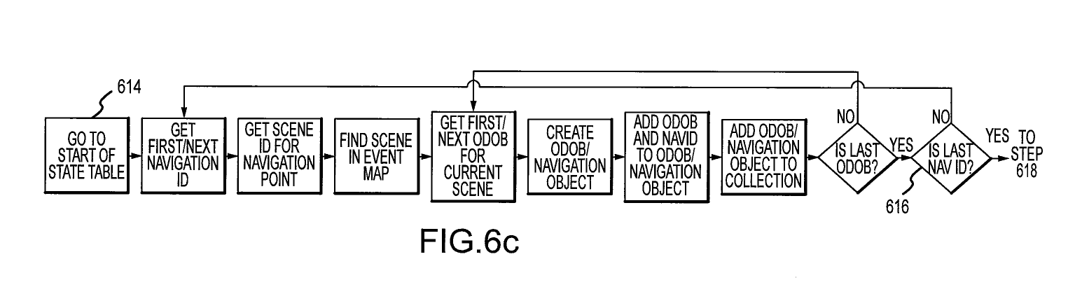

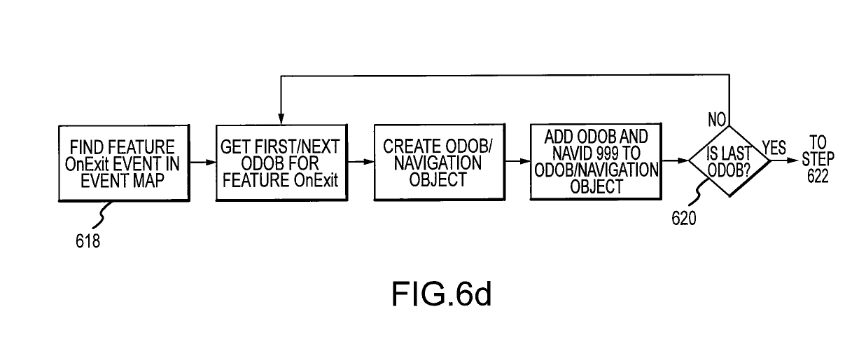

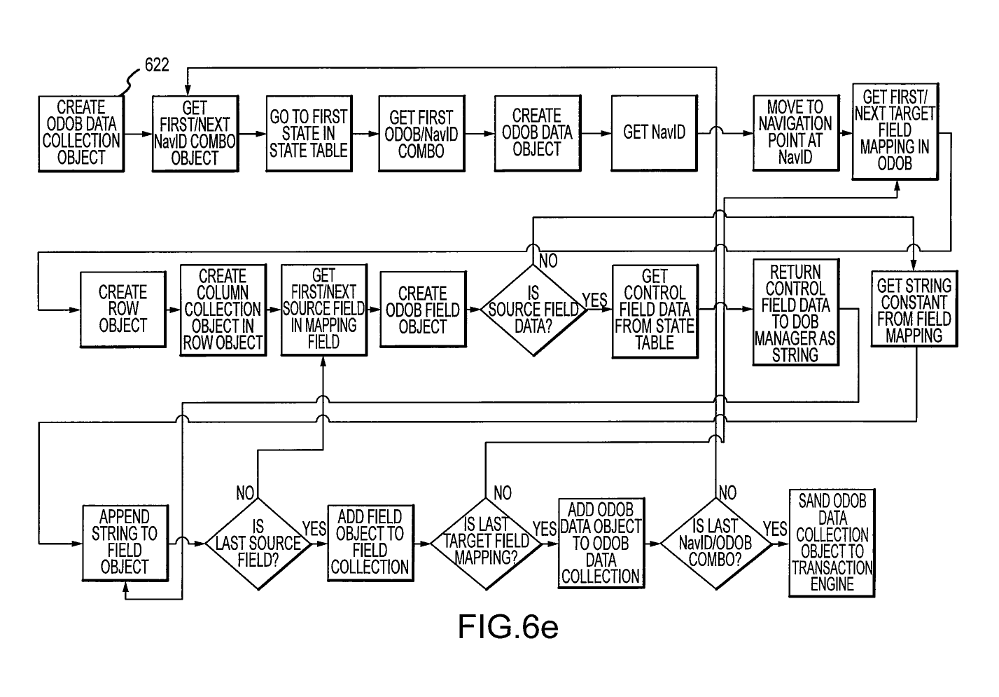

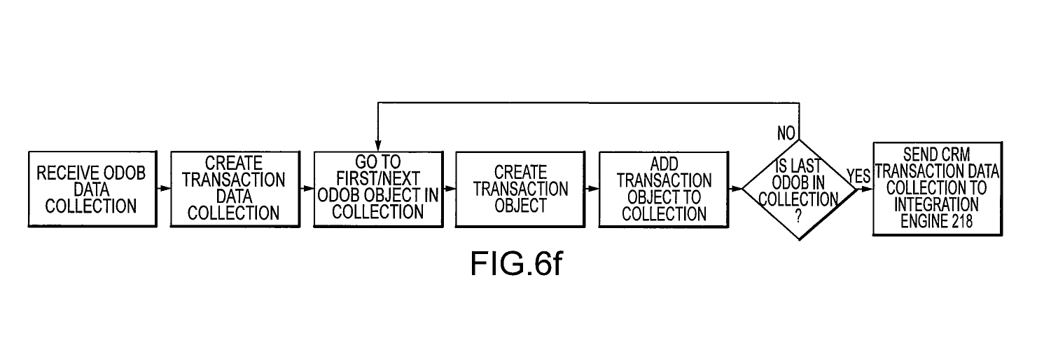

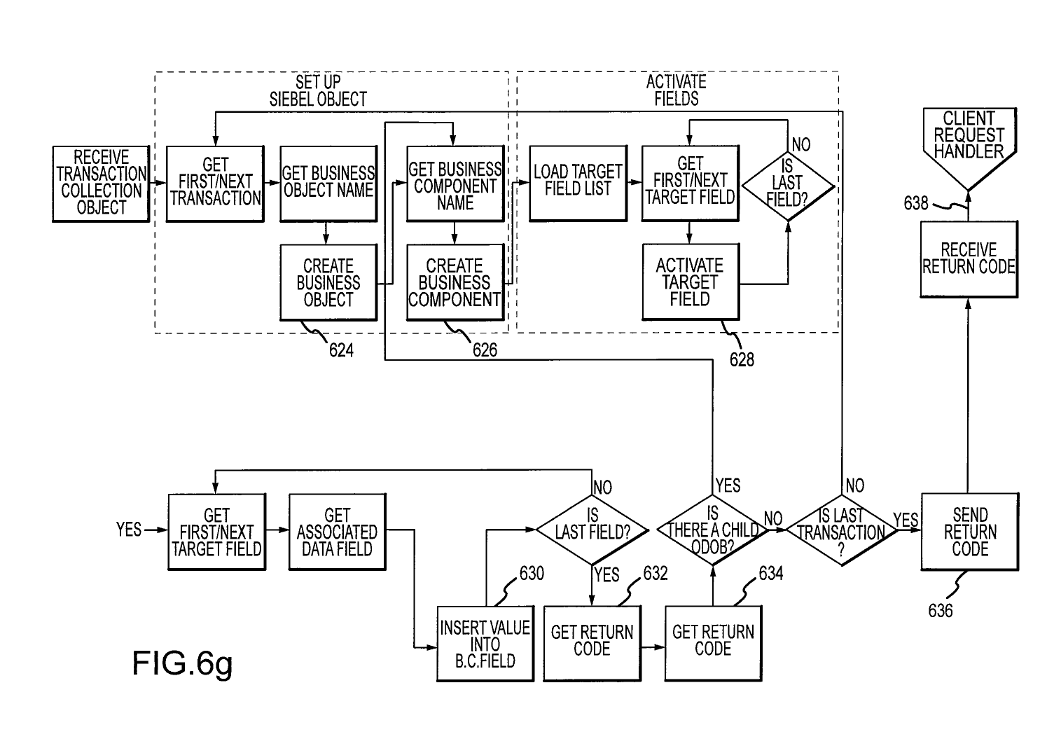

Additional detail regarding the writing of information from the state tables to the CRM data set is provided below with reference to FIGS. 6a to 6f. Referring first to FIGS. 5 and 6a, the sub-steps steps step 550 to generate the state table and feature xml files for passing to data object manager 222, is shown in FIG. 6a. Therein, remote client module 204 requests and retrieves xml files through repository manager 214 in steps 602, 604, 606 and 608.

Processing by data object manager 222 and the sub-steps of step 552 of FIG. 5 are shown in FIG. 6b-6g. In FIG. 6b, the xml files are received at step 607 and a ODOB data collection object is generated at step 608. In step 609, a feature OnLoad event (that is, the loading of a feature presentation such as presentation 202) is found on the event map file, and then at step 610 data in the for this event is added until there is no further data in this respect at step 612, which then proceeds to step 614 shown in FIG. 6c.

In FIG. 6c, the mapping of data in the navigation state table to the ODOB data collection object is shown in detail. Therein, at step 614 data object manager 222 goes to the start of the state table and then proceeds through to step 616 to map information in the state tables in the odob.xml file to the ODOB data collection object, for response information relating to each navigation event stored in the state table. Thereafter, processing continues onto step 618 shown in FIG. 6d.

In FIG. 6d, a feature OnExit (i.e., exiting presentation of a feature to an audience) event is mapped to the ODOB data collection, as shown in steps 618 through 620, after which processing continues to step 622 shown in FIG. 6e.

In FIG. 6e, detailed information regarding the generation of an ODOB data collection object is provided in the flow chart as shown. As will be appreciated by one of skill in the art, the ODOB data collection is a collection of data objects comprising mapped data from the state tables.

Referring to FIG. 6f, details of processing by transaction engine 216 in step 554 as shown in FIG. 5c is provided.

Referring to FIG. 6g, details of exemplary processing by a CRM data management system, such as by CRM client 108 alone or in conjunction with CRM server 102, is shown. For this example, many of the steps shown are related to implementation on a Siebel™ system, however, it will be appreciated that implementation on other CRM data systems is possible with slight modification in other embodiments. In FIG. 6g, steps 624, 626, 628, 630, 632 and 634 are processed at the CRM integration engine 218 and CRM data set level, and after completion of all transactions of the CRM transaction data collection, a return code is sent from the transaction engine 216 to the client module 214 in steps 636 through 638, for which some details from the operation shown in FIG. 5c are omitted in FIG. 6g.

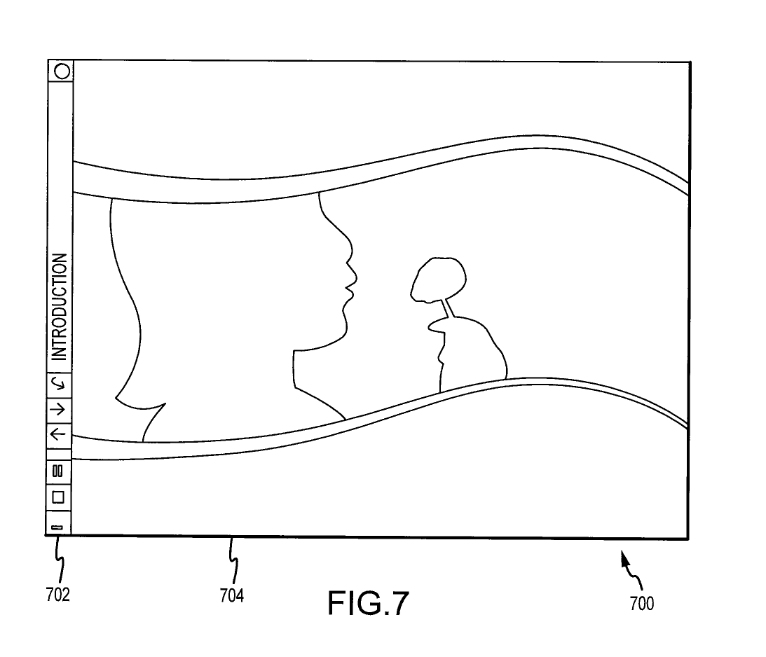

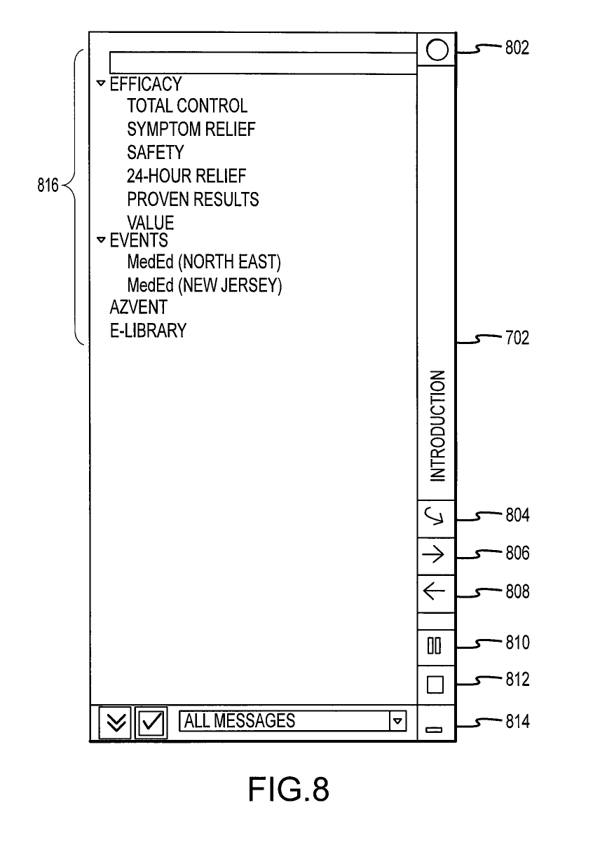

In the embodiment, presentation manager 110 provides additional functionality for assisting in capturing response information as a presentation is being presented to an audience. Referring to FIG. 7, there is a screen display 700 of a scene in an exemplary presentation presented by presentation player module 208 to I/O peripherals 126. Screen display 700 includes area 704 for displaying scenes of a feature presentation, and navigation bar 702 for controlling navigation between scenes and accessing functions of presentation manager 110. Referring to FIG. 8, a more detailed view of navigation bar 702 is provided. Bar 702 includes scene list button 802, which when selected provides a list of scenes to a feature presentation that the presenter can then select and navigate to. In FIG. 8, an exemplary list of scenes to an exemplary feature are shown in pull-out menu 816.

Navigation bar 702 further includes pause button 808 to pause the presentation being shown, stop button 812 to stop playing of the presentation, and minimize button 814 to minimize the presentation player module 208 screen display on an output display of I/O peripherals 126. Bar 702 also includes back/next buttons 806/808 to respectively backtrack or advance through the presentation. Bar 702 further includes a “new call” button 804. When activated, button 804 causes presentation manager 110 to create a new marker in the data tracked for the presentation being displayed, so that the data that is tracked before and after button 804 is selected can be identified and analyzed separately later on. For example, in the embodiment selection of button 804 causes presentation manager to stop writing to the current navigation state tables in the current output data object file, and generate new navigation state tables in a new output data object file to track response information to the presentation after button 804 is selected. This can tend to be useful if, for instance, a new target member of the audience joins a presentation that is underway to another member of the audience, and the presenter would like to subsequently track response information geared towards the new target member or the group of audience before him. In this way, the functionality of call button 804 provides the presenter with the ability to discretely make note that a new target member has joined the presentation at a particular moment in the presentation, and separate the subsequent response data that is tracked to the data previously tracked for before the new target member joined. While a new state table and an output data object are generated as button 804 is activated in the embodiment, it will be appreciated that in other embodiments, different methods may be used to provided a marker to track response information after activation of button 804.

Still additional functionality of presentation manager 110 is described below. Prior to and after a sales visit, system 100 can provide a sales presenter with opportunity to prepare a presentation that is customized to the target customer or audience, and an opportunity to enter notes post-visit relating to the presentation to the audience, so that a presentation is integrated with a CRM system.

Referring to FIG. 9, an exemplary screen display 900 is shown for a pre-call, or pre-visit, configuration tool that is provided by presentation manager 110. In screen display 900, there is a pull-down menu box 902 for selecting a presentation that is pre-defined and available at mobile computing device 106 for presenting to an audience. Different layouts, such as excerpts only, or all messages and scenes, for a presentation can be selected from pull-down menu box 904. Pre-call screen display 900 further includes an audience target area 912, in which customer identification data, such as data retrieved from an underlying CRM data set, is provided. From area 912, a presenter can pre-select the target audience. In the embodiment, presentations can be customized to different customers or different customer characteristics defined with a customer in the CRM data set, so that the selected presentation may be modified to better suit the selected customer, or target audience.

Once the target audience, presentation, and layout have been selected, button 906 may be activated to obtain an overview of the presentation to be shown. Button 908 provides access to another tool of presentation manager 110 to edit the layout of the selected presentation. Button 910 provides access to a preview of the presentation. The pre-call display screen therefore provides a presenter with an ability to modify their presentation as appropriate before presenting to the intended audience and prior to tracking response data, although of course if a customer is selected from area 912 then the tracking of response information will be linked to the selected customer as the audience.

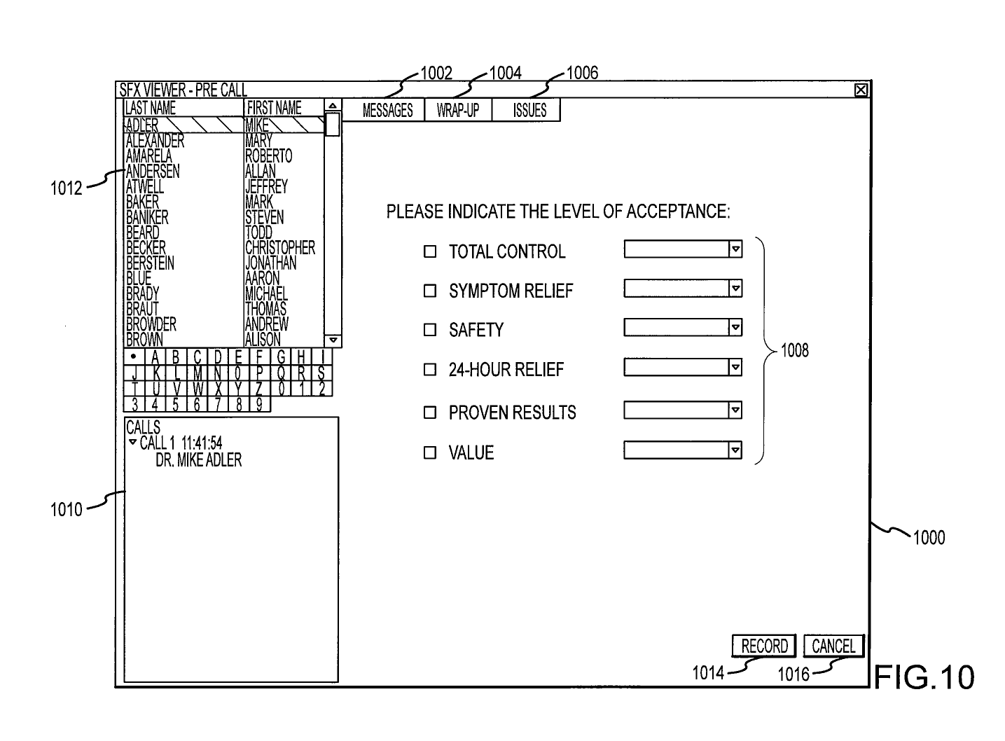

Information regarding an audience, and other information relating to a presentation, can also be entered into a CRM data set through presentation manager 110 after a call is completed. After completion of a presentation, the presenter can then access a post-call screen display 1000 provided by presentation manager 110. In exemplary display 1000 in FIG. 10, there are three tabs 1002, 1004 and 1006 providing areas for entering additional information that can be captured as response data and stored with the underlying CRM data set. As shown in FIG. 10, tab 1002 for “Messages” is selected, and in area 1008 there are different exemplary messages that the presentation just made to an audience was expected to deliver. In area 1008, the level of acceptance by a target audience to different messages can be selected.

In area 1010, different “calls” that were made is displayed. In the example shown in area 1010, there is only a single call. However, if there were multiple calls, or if new call button 804 was activated during a presentation, additional “calls” would be listed in area 1010, and a different target audience can then be selected for each call from area 1012 that provides a list of customers in the underlying CRM data set. New customers can also be added through presentation manager 110 to the CRM data set. Each call is provided with a different set of tabs 1002, 1004 and 1006 so that response information for each call can be entered and tracked separately. A cancel button 1016 is also provided to cancel changes or data entered in post call screen 1000.

In the embodiment, record button 1014 is provided to initiate recording of the response information captured during a presentation, including data from post-call screen 1000, to the underlying CRM data system. With reference to FIGS. 2, 5 and 6a-6g described above, in the embodiment the response information is held in non-persistent state table as output data objects (and xml files) until record button 104 is activated, and then the CRM data update as described above is performed to update the underlying CRM data set with the response information. It will be appreciated that other CRM data update schemes, including real time updates as response information is captured, can be used for other embodiments.

The response information captured by presentation manager 110 tends to be useful for providing feedback to the effectiveness of a presentation made an audience. The response information can be analyzed with respect to an individual target customer, or with respect to a market segment sharing one or more common characteristics, depending on the business intelligence that a user of system 100 is seeking to obtain.

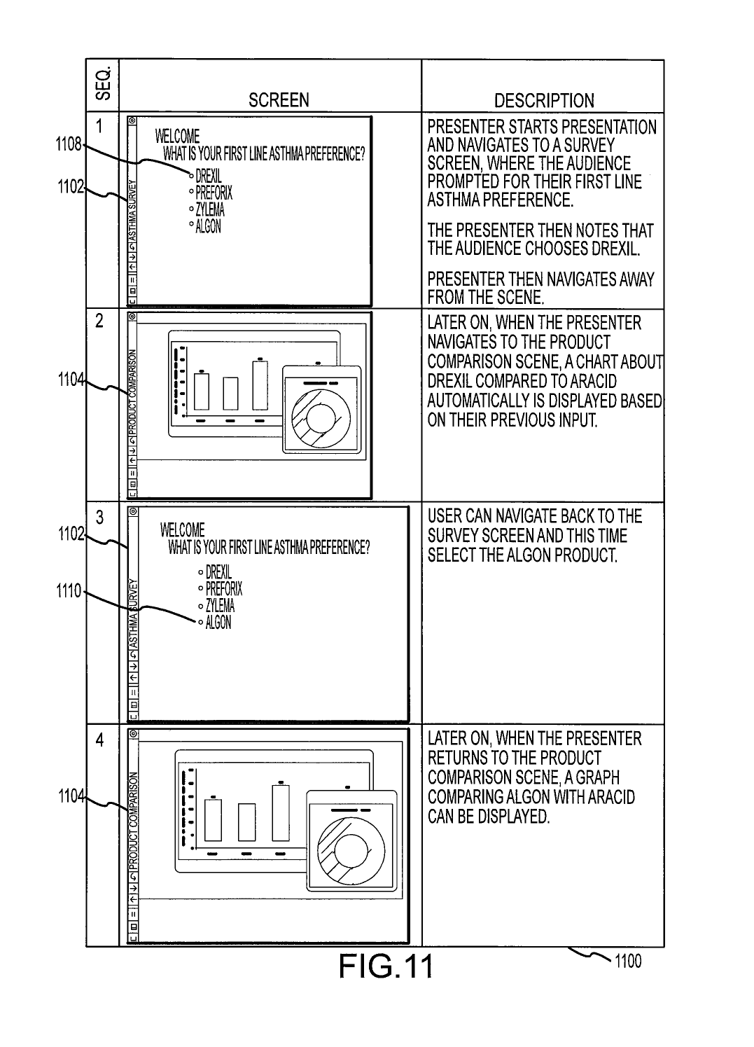

In the embodiment, real-time feedback can be used to tailor a presentation to the particular audience during the presentation as response information from earlier parts of the presentation is captured and analyzed. Referring to FIG. 11, a table 1100 is shown having exemplary screen displays, or scenes, of a presentation shown in sequence numbered from 1 through 4. For this exemplary presentation, a presenter is showing a presentation on a notional product, Aracid, which is notionally for asthma treatment. Referring first to the screen of sequence no. 1, a presenter brings up a scene 1102 on which the audience is asked for their preference on their first line Asthma preference. If the audience responds that it is “Drexil”, then an interactive checkbox 1108 for Drexil is selected in scene 1102. As described above, this selection can be captured as response information and tracked, as described above.

Later on in the presentation, based on the earlier response information selecting Drexil, in the screen for sequence no. 2 showing scene 1104, a chart or other product comparison display is shown comparing Aracid to the earlier selected product of Drexil. In this example, the feature presentation is automatically customized in real time to show a product comparison of the product being presented (i.e., Aracid), to a product that the audience has previously indicated a preference for (i.e., Drexil).

Continuing with this example, if the presenter navigates back to scene 1102 and selects another product, Algon, as the audience's first line Asthma preference by selecting button 1110 (as shown in sequence no. 3 on table 1100), then if the presentation returns to scene 1104, now this scene shows a comparison between the product being promoted, Aracid, and the previously select Algon product.

In the example of FIG. 11, the response information is used by presentation manager 110 to modify a presentation in real time, and the same response information is also provided to the underlying CRM data system. In other examples, the feedback can be obtained through the CRM data system and analytics performed thereupon.

In the embodiment, system 100 includes a feedback manager (FM) module with CRM server 102 to analyze response information captured in presenting feature presentations. It will be appreciated that the FM module need not be implemented on CRM server 102, and that in other embodiments, a FM module can be implemented anywhere accessible by system 100, including at a mobile device on which presentation manager is operating.

FM module analyzes response information along with other CRM information to provide predictive modeling of a target customer's likely response to specific promotional approaches, including through scenes of feature presentations. FM module can provide a report on specific approaches that are deemed to be successful and unsuccessful, and provide recommendations for refining existing scenes of presentations. Such analysis and reporting can be tailored to an individual targeted customer, such as a doctor, or to customers that share common attributes in the CRM data set, such as doctors of a particular speciality.

FM module tends to permit each presenter to leverage past successes in presentations into future presentations, and to leverage successes of other presenters using system 100 into his or her own further presentations.

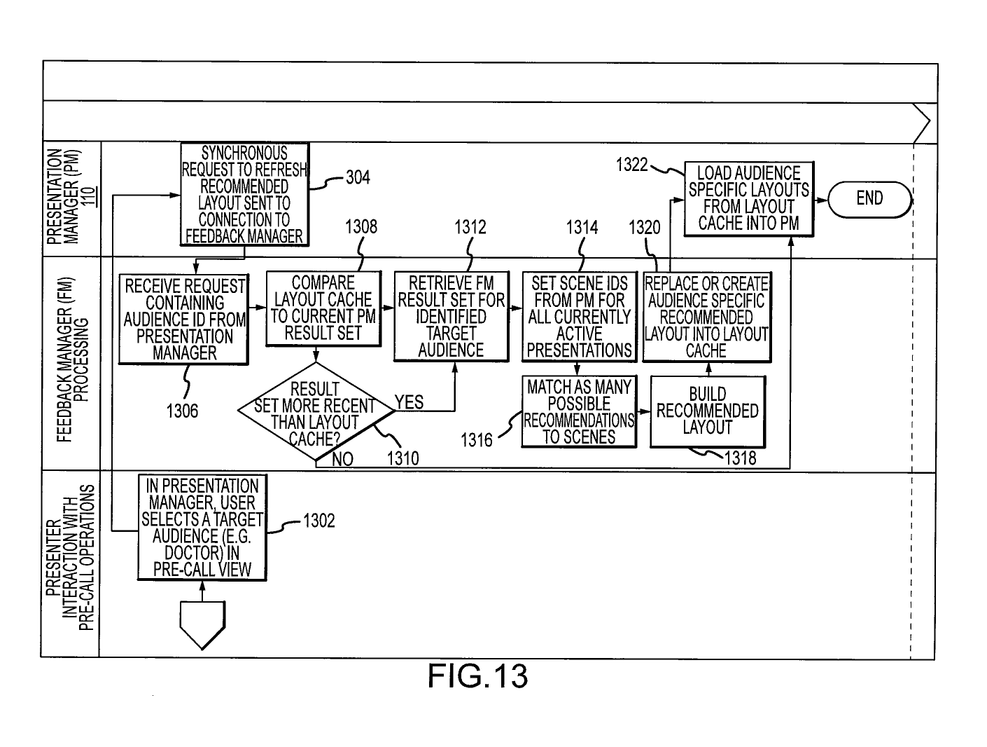

In the embodiment, the incorporation of FM recommendations for scenes to use in a presentation is provided through the pre-call interface screen 900 shown in FIG. 9. Thereon, after a target audience is selected in area 912, by selecting the pre-call tab 914, an option in the newly selected tab (not shown) will appear with an option to request a refresh of recommended layouts. Referring to FIG. 13, this selection of a target audience and requesting refresh of layouts is shown as steps 1302 and 1304, respectively. The request is then passed to FM module at step 1306, which at 1308 and 1310, compares the cache of layouts for presentations with the current FM recommendation result set. If the FM result set is more recent than the layout cache, then at 1312 the FM result set is retrieved for the identified target audience. At 1314, scene identifications for all currently active presentations at presentation manager 110 is obtained and provided to FM module. At step 1316, FM module attempts to match recommended scenes to available scenes of presentation manager 110. Then at step 1318, a recommended layout in response to the request from 1304 is generated, based on matched recommended scenes from 1316. The newly built recommended layout is stored at 1320 into the cache of layouts, either as a new cache entry or as a replacement for an existing, but no longer recommended, layout. The newly available layout(s) are then loaded to presentation manager 110 at step 1322 and is made available to a presenter to select from pre-call tab 914 in the pre-call interaction screen 900. It will be appreciated that in other embodiments, the layout update process described with reference to FIG. 13 need to be initiated by a user, and can be conducted automatically by system 100 to periodically, or upon a trigger event, update the layouts available at each presentation manager module 110 operating at different mobile computing devices 106.

For the embodiment, the generation of a FM recommendation result list is by way of analysis of which marketing message, such as embodied in a scene of a presentation, have the best “target metric” for the product to be promoted and the target audience. The target metric is a result obtained through analysis by way of a predictive model based on the data collected in response information to presentations and other CRM data. In the embodiment, the predictive model analysis of EM module is performed by a SMI software package by Success Metrics Inc., which is built on the WEKA data mining platform. It will be appreciated by those of skill in the art that other predictive models may be used in other embodiments.

FM module provides the data set to be analyzed by the predictive model, and indicates to the model the metrics and attributes to be used to categorize the data. The target metrics are used to measure the impact of a promotional message, such as presented through a scene of a presentation, on the targeted audience. The metric for a message/audience pair will increase as a positive relationship is established by the model between the message and the target audience, and decrease if the impact of the message is modelled to be negative. Over time, if the metric for a message increases, then it becomes a recommended message for the target audience.

Attributes can be defined on metrics/audience pairs. A first set of such attributes can be for grouping target audiences into groups having one or more shared characteristic, as set out in the underlying CRM data. A second set of attributes can be specified for doctors, and be for grouping such an audience based on prescription patterns. Such attributes might be defined over many target and non-target audience specific metrics. Other metrics and attributes can also be defined to suit the needs of a user in crafting their desired intelligence report or FM recommended message set.

For generating the FM recommended message set, the recommendations are ranked based on their predicted effect, or metric, upon a target audience. Thus, in an implementation based on promotion of a pharmaceutical, there can be produced a list of ranked messages that are predicted to have a positive influence on the number of times that a target doctor will prescribe the pharmaceutical being promoted.

Again using a doctor target audience and promotion of a pharmaceutical as an example, once response information for different scenes of different presentations have been updated to the underlying CRM system of system 100, an ETL tool may be used to migrate that data to a fact table in a data warehouse for mining by FM module. While many varieties of target metrics can be defined, for this example it is assumed that the metric is market share. This metric is linked to the fact table to a message fact table. The message fact table sets out the different messages that are delivered in scenes of presentations. The attributes of this linked relationship can then be placed into the predictive modeling tool of EM module, which takes the attributes defined and performs a number of different statistical models to define a relationship between the metric (i.e., market share) with the messages. Thus, the output of the modeling can be integrated with other data to learn: to which doctor (or target audience) a particular message or scene has been presented, and the messages that are most likely have an impart on the doctor based on the modeling results.

This output information can be aggregated based on attributes as well, which can include the geographic locations of doctors, and the size of the doctors' practices, to provide some generalized market intelligence on the impact of messages. This information can be summarized in a report that can be generated by EM module, and the entire set of output from the modeling analysis can also be queried to obtain a list of the mostly likely to be impactful messages as a recommended message set based on particular physician attributes, and which message set can then be used to update presentations and layouts in an attempt to increase message impact.

For example, the modelling parameters for an exemplary model that can be analyzed by EM module is provided below:

Sample Model Parameters

| Model Overview | A different model is created to measure the impact of each message. |
|---|---|
| | Each model is constrained to only consider data for the relevant |
| | product, message and time period. |
| Target Metric | Description |
| Changed Market | The metric is specific to the product and time period being measured |
| Share | and analyzed. For this example, the changed market share is the |
| | difference in market share between the previous quarter and the |
| | current quarter. |
| Target Dimension | Description |
| W_PERSON_D | This indicates that the effect of the message will be measured against |
| | each individual doctor. Only doctors who have been delivered the |
| | relevant message within the target time period are included in this |
| | model |
| Target Attribute | Description |
| Average Patients | Average number of patients that the doctor has treated in the |
| | specific market for the drug of the message over the last year |
| Current Patients | Current number of patients in the specific market |
| Volatility | Average change on market share from quarter to quarter over the |
| | last year |
| Decile | Current decile ranking for specific doctor for TRx of specific drug in |
| | market |
| Average Decile | Average decile ranking for specific doctor for TRx of specific drug in |
| | market over last year |
| Average Decile | Difference between specific doctor decile and overall organization |
| Diff Org | decil |
| Average Share | Avergare market share for specific doctor for specifc drug |

Pattern Evaluation

Measure total messages delivered
Measure changed market share
Measure total messages vs. message category
Measure total messages vs. product
Measure total messages vs. language spoken
Measure total messages vs. specialty
Measure total messages vs. area of interest
Measure total messages vs. geography
Measure total messages vs. first segment
Measure total messages vs. first segment and first segment product
Measure total messages vs. first segment and first segment ranking
Measure total messages vs. first segment and first segment rating
Measure total messages vs. second segment and second segment product
Measure total messages vs. second segment and second segment ranking
Measure total messages vs. second segment and second segment rating
Measure total messages vs. second segment
Measure total messages vs. doctors seen per position
Measure total messages vs. position top segment
Measure total messages vs. position top product
Measure total messages vs. position second product
Measure total messages vs. position second segment
Measure changed market share vs. message category
Measure changed market share vs. product
Measure changed market share vs. language spoken
Measure changed market share vs. specialty
Measure changed market share vs. area of interest
Measure changed market share vs. geography
Measure changed market share vs. first segment
Measure changed market share vs. first segment and first segment product
Measure changed market share vs. first segment and first segment ranking
Measure changed market share vs. first segment and first segment rating
Measure changed market share vs. second segment and second segment product
Measure changed market share vs. second segment and second segment ranking
Measure changed market share vs. second segment and second segment rating
Measure changed market share vs. second segment
Measure changed market share vs. doctors seen per position
Measure changed market share vs. position top segment
Measure changed market share vs. position top product
Measure changed market share vs. position second product
Measure changed market share vs. position second segment

Using the above sample model parameters, EM model performs a statistical analysis to obtain a metric for the change in market share target metric.

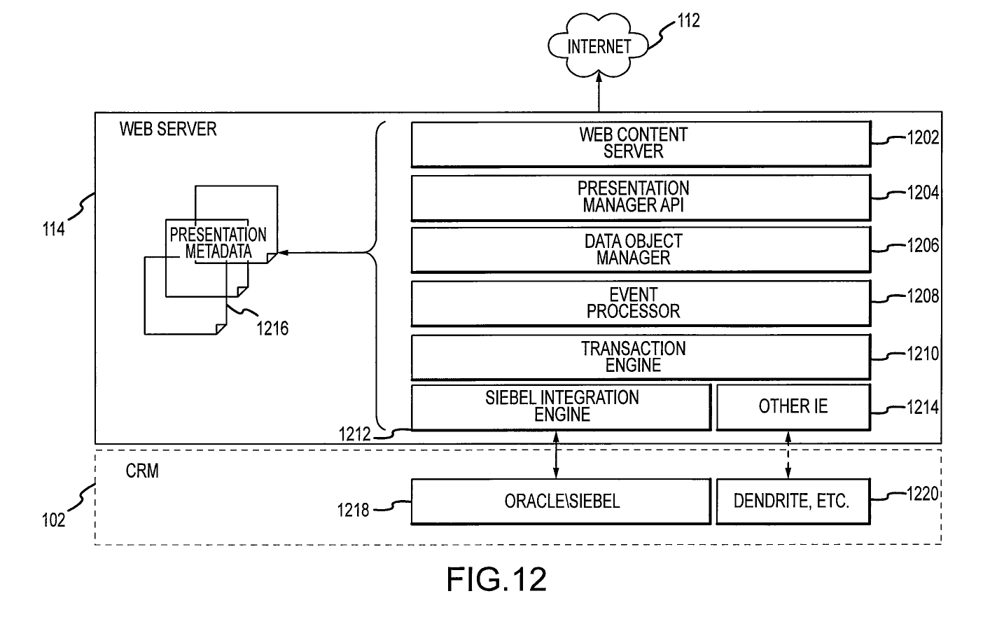

Referring to FIGS. 1 and 12, an alternative CRM data access method over the Internet is described. In the access scheme shown in FIG. 12, much of the functionality of presentation manager 110 described above is provided instead by web server 114, so that a presentation and the capture of response information is handled by way of web-content over the Internet 112, as the presentation is provided to a “thin” client 116. For the embodiment, client 116 access can include merely displaying the presentation in a web browser at client 116, with the response information tracked by web server 114.

In web server 114, a presentation manager (PM) API 1204 provides similar functionality as the client module 204 of presentation manger 110 described above. PM API 1204 controls the presenting of a feature, or a presentation, to an audience and the capture of response information through a web content server 1202. Web server 114 further includes a data object manager module 1206 similar to data object manager module 222 described above. This and other components of web server 114, such as event processor 1208, transaction engine 1210, CRM integration engine for Siebel™ 1212, and another integration engine 1214, are all similarly implemented as in presentation manager 110 described above, and hence operation of these aspects of web server 114 is not repeated here.

However, because web server 114 operates with CRM server 102 in the embodiment, the integration engines 1212 and 1214 connect directly to corresponding engines 1218 and 1220, respectively, on CRM server 102 rather than CRM client 108. It will be appreciated that in other embodiments in which the web server operates separately from a CRM server, then the web server may connect to a CRM client instead, which CRM client then maintains a connection to the server, similarly to the connection of CRM client 108 to CRM server 102 described above.

Web server 114 further differs from presentation manager 110 in that the presentations include metadata, and the presentation scenes are all passed as web accessible content to web content server 1202 for hosting, so that the presentation can be viewed over Internet 112. As a user navigates through a presentation hosted by web server 114, the navigation details (including, links clicked on, time spent on each web page, number of times a web object is activated, etc.) are logged by web content server 1202 and passed onto PM API 1204. This response data is captured and stored into xml format as before with presentation manager 110, which can then be stored onto the underlying CRM system at CRM server 102. It will be appreciated by a person of skill in the art that the functionality described above with respect presentation manager 110 can be provided through web server 114 with modifications as would be apparent to such person.

For the embodiment, in use of either presentation manager 110 or web sever 114, an authentication scheme is implemented to restrict unauthorized access to the presentations and underlying CRM data.

It will be appreciated from the above examples that a myriad of components may be used to implement embodiments of the invention.

Although the invention has been described with reference to certain specific embodiments, various modifications thereof will be apparent to those skilled in the art without departing from the spirit and scope of the invention as outlined in the claims appended hereto.

We claim:

1. A customer relations management (CRM) system for capturing response information to a presentation to an audience, comprising:
a presentation module for presenting objects of the presentation to the audience;
a tracking module for capturing the response information during presentation of the objects of the presentation to the audience; and
a data storage for storing the response information.

2. The CRM system for capturing response information as claimed in claim 1, further comprising:
a response analysis module for analyzing the response information to determine effectiveness of at least one of the objects of the presentation; and
an update module for modifying the at least one of the objects on the basis of the effectiveness determined by the response analysis module.

3. The CRM system for capturing response information as claimed in claim 2, wherein the effectiveness determined by the response analysis module is stored in a response report on the data storage.

4. The CRM system for capturing response information as claimed in claim 3, wherein the presentation module provides a new call object in the presentation that is activatable to initiate tracking of second response information by the tracking module, the response information relating to response of the audience during a first segment of the presentation, and the second response information relating to response of the audience during a second segment of the presentation.

5. The CRM system for capturing response information as claimed in claim 4, wherein:
the audience comprises at least a first and a second party;
the first party provides the response during the first segment of the presentation;
the new call object is activated as the second party joins the presentation; and
at least the second party provides the response during the second segment of the presentation.

6. The CRM system for capturing response information as claimed in claim 5, wherein the presentation and tracking modules are part of a client program that reside upon a mobile computing device used by a presenter to present the presentation to the audience.

7. The CRM system for capturing response information as claimed in claim 6, wherein the response analysis and update modules are part of a server program that resides upon a computing system remote from the mobile computing device.

8. The CRM system for capturing response information as claimed in claim 7, wherein the client (i) provides the response and second response information to the server program for analysis by the response analysis module, and (ii) receives commands for modifying the at least one objects of the presentation from the update module of the server.

9. The CRM system for capturing response information as claimed in claim 8, wherein the client program communicates with the server program via the Internet.

10. The CRM system for capturing response information as claimed in claim 9, wherein the data storage includes a CRM database for storing the response information and other customer data in the CRM system.

11. A method for capturing response information to a presentation to an audience, comprising:
presenting objects of the presentation to the audience;
tracking the response information during presentation of the objects of the presentation to the audience;
analyzing the response information to determine effectiveness of at least one of the objects of the presentation; and
modifying the at least one of the objects on the basis of the determined effectiveness.

12. The method for capturing response information as claimed in claim 11, wherein the effectiveness determined by the response analysis module is stored in a response report on the data storage.

13. The method for capturing response information as claimed in claim 12, further comprising initiating tracking of second response information, wherein the response information relates to response of the audience during a first segment of the presentation, and the second response information relates to response of the audience during a second segment of the presentation.

14. The method for capturing response information as claimed in claim 13, wherein:
the audience comprises at least a first and a second party;
the first party provides the response during the first segment of the presentation; and
at least the second party provides the response during the second segment of the presentation.

15. The method for capturing response information as claimed in claim 14, wherein the steps of:
presenting objects of the presentation to the audience; and
tracking the response information during presentation of the objects of the presentation to the audience,
operate on a mobile computing device.
